(19) United States
(12) Patent Application Publication
(10) Pub. No.: US 2011/0223384 A1
(43) Pub. Date: Sep. 15, 2011

(54) Novel mineral composition

(76) Inventors: Robert H. Whitaker, Cleveland, GA (US); Allen E. Smith, Sparta, NJ (US)

(21) Appl. No.: 13/066,571

(22) Filed: Apr. 18, 2011

Related U.S. Application Data
(63) Continuation-in-part of application No. 12/657,528, filed on Jan. 22, 2010.
Application No. 12/657,528 is a continuation-in-part of application No. 11/999,205, filed on Dec. 4, 2007, now Pat. No. 7,651,559.
Application No. 11/999,205 is a continuation-in-part of application No. 11/638,618, filed on Dec. 13, 2006, now abandoned.
Application No. 11/638,618 is a continuation-in-part of application No. 11/266,833, filed on Nov. 4, 2005, now abandoned.
Application No. 11/266,833 is a continuation-in-part of application No. 12/927,442, filed on Nov. 15, 2010.
Application No. 12/927,442 is a continuation-in-part of application No. 11/405,966, filed on Apr. 18, 2006, now Pat. No. 7,833,339.

(51) Int. Cl. D06N 7/04; B05D 7/00; B32B 37/00

(52) U.S. Cl. 428/143; 427/221; 156/62.2

(57) ABSTRACT

A shingle assembly that contains a fiber mat and an asphalt mixture disposed within the fiber mat. The asphalt mixture contains asphalt and a mineral filler; a layer of mineral granules is disposed on the top surface of the shingle assembly; the mineral granules contain at least about 40 weight percent of limestone particles that have a hardgrove grindability index of less than 70; and the particles are coated with an oil.

### CROSS-REFERENCE TO RELATED PATENT APPLICATION

This patent application is a continuation-in-part of applicants' copending patent application Ser. No. 12/657,528 (filed on Jan. 22, 2010), which in turn was a continuation-in-part of copending patent application Ser. No. 11/999,205 (filed on Dec. 4, 2007, now U.S. Pat. No. 7,651,559), which in turn was a continuation-in-part of patent application Ser. No. 11/638,618 (filed on Dec. 13, 2006), which in turn was a continuation-in-part of patent application Ser. No. 11/266,833 (filed on Nov. 4, 2005). The entire disclosure of each of such patent applications and of such patent is hereby incorporated by reference into this specification.

This patent application is also a continuation-in-part of copending patent application Ser. No. 12/927,442 (filed on Nov. 15, 2010), which in turn was a continuation-in-part of copending patent application Ser. No. 11/405,966 (filed on Apr. 18, 2006, now U.S. Pat. No. 7,833,339). The entire disclosure of such patent application and of such patent is hereby incorporated by reference into this specification.

### FIELD OF THE INVENTION

A shingle assembly comprised of a mineral filler and limestone roofing granules.

### BACKGROUND OF THE INVENTION

Roofing shingles are comprised of a headlap portion and a butt portion; granules are often used in both of such portions. Reference may be had, e.g., to U.S. Pat. No. 3,921,358 (a composite asphalt-impregnated felt roofing shingle comprising a rectangular sheet having a headlap portion and a butt portion), 4,717,614 (a shingle whose headlap portion is coated with a layer of asphaltic material), 4,900,589 (a process for applying granules to a moving sheet having a headlap area and a butt area for making a shingle roofing product), and 6,358,305 (a process of preparing a darkened headlap for a roofing shingle). The entire disclosure of each of these United States patents is hereby incorporated by reference into this specification.

U.S. Pat. No. 6,358,305 of Ingo B. Joedicke discloses a process for the preparation of coated “base granules” that may be used in the headlap portions of shingles. In Joedicke's process, a suspension is used that contains an an organosilicon compound, a hydrocarbon oil, drying oil, and carbon black; the suspension is mixed with the “base granules” in, e.g., a rotary mixer.

In the examples presented in the Joedicke patent, a “ . . . dedusted headlap-grade crushed rock aggregate of no. 11 grading . . . ” was coated with such suspension (see column 5, lines 7-10). Although this process allegedly worked with “crushed rock aggregate” to improve the adhesion properties of such rock aggregate, it is not suitable for preparing headlap roofing granules with improved adhesion properties when the “base granules” are limestone. When a headlap roofing material is made from “limestone base material” using the process disclosed in the Joedicke patent, the adhesion properties of the headlap roofing granules so produced are not satisfactory; when they are tested in accordance with A.S.TM. standard test D4977-3, they lose more than 5.0 grams of material.

It is an object of this invention to provide an improved shingle assembly that is comprised of at least 40 weight percent of limestone headlap granules wherein such shingle assembly has satisfactory adhesion properties.

It is another object of this invention to provide a process for producing such shingle assembly.

### SUMMARY OF THE INVENTION

In accordance with this invention, there is provided a shingle assembly comprised of a fiber mat and an asphalt mixture disposed within said fiber mat. The asphalt mixture contains asphalt and a mineral filler; a layer of roofing granules is disposed on the top surface of the shingle assembly; the roofing granules contain at least about 40 weight percent of calcium carbonate, and they have a hardgrove grindability index of less than 70; and the particles are coated with an oil.

### BRIEF DESCRIPTION OF THE DRAWINGS

The invention will be described by reference to the following drawings, in which like numerals refer to like elements, and wherein:

FIG. 1 is a flow diagram of one preferred process of the invention;

FIG. 2 is a schematic of a test apparatus for determining the hydrophobicity of coated particles;

FIG. 3 is a flow diagram of a process for coating headlap granules with resin and pigment;

FIG. 4 is a schematic diagram of a preferred process of the invention; and

FIG. 5 is a schematic diagram of a shingle comprised of headlap particles.

### DESCRIPTION OF THE PREFERRED EMBODIMENTS

Roofing granules are well known to those skilled in the art. Reference may be had, e.g., to U.S. Pat. Nos. 3,884,706 (algicidal roofing granules), 4,092,441 (roofing granule treatment by coating with a metallic algicide), 4,359,505 (light colored roofing granules), 5,380,552 (method of improving adhesion between roofing granules and asphalt-based roofing materials), 6,156,289 (iron based roofing granules and method of coloring the same), 6,607,781 (roofing granules with a decorative metal appearance), 7,060,658 (roofing granules), and the like.

Roofing granules made from coal slag have excellent adhesion properties. However, some have expressed concerns about the safety of coal slag (in general) and of roofing granules made from coal slag. It would be desirable to be able to make roofing granules with good adhesion properties from a more “environmentally friendly” material than coal slag.

Limestone is a substantially more “environmentally friendly” material than coal slag. Thus, e.g., limestone is often fed to chickens as a feed supplement. However, the adhesion properties of limestone granules are often not deemed to be adequate for use in roofing shingles.

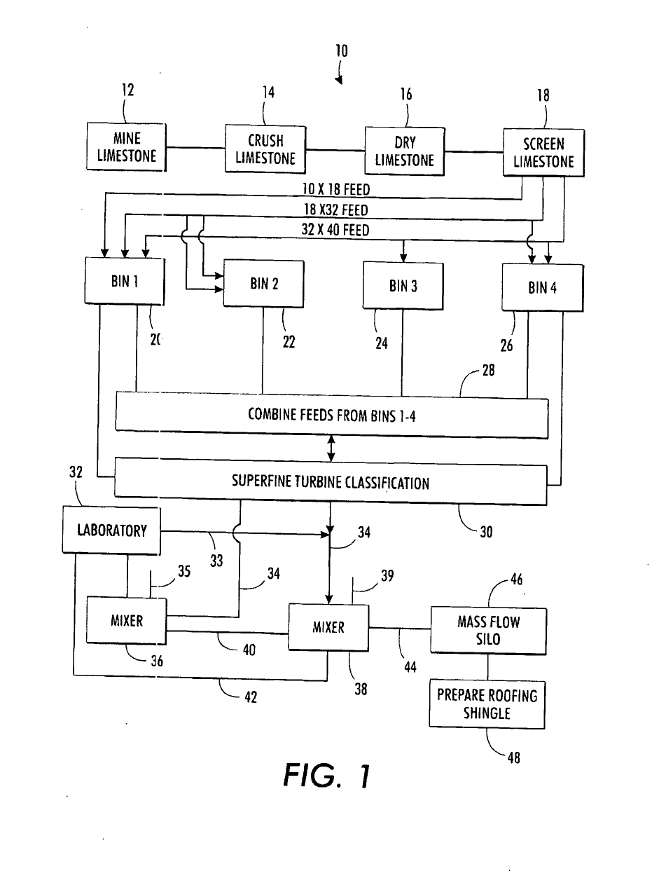

FIG. 1 is a flow diagram of a preferred process 10 for preparing some preferred limestone roofing granules of this invention that have improved adhesion properties. In step 12 of this process, the limestone is mined by conventional means. The limestone so mined preferably contains at least about 40 weight percent of calcium carbonate. In one embodiment, such limestone preferably contains at least about 80 weight percent of calcium carbonate and, more preferably at least about 90 weight percent of calcium carbonate.

The term “limestone,” as used in this specification, has the meaning set forth at pages 475-476 of George S. Brady et al.'s “Materials Handbook,” Thirteenth Edition” (McGraw-Hill, Inc., New York, N.Y., 1991). As is disclosed at such page 475, limestone is “A general name for a great variety of calcite rocks . . . . In a broad sense limestone include dolomite, marble, chalk, or any mineral consisting largely of CaCO₃. When the proportion reaches 45% and the limestone is in the double carbonate, CaCO₃.MgCO₃, it is called dolomite.”

Limestone, processes for mining it, processes for treating it, methods of using it, and compositions containing it are well known to those skilled in the art. Reference may be had, e.g., to U.S. Pat. Nos. 3,601,376 (process for preheating limestone), 3,617,560 (limestone neutralization of dilute acid waste waters), 3,722,867 (method of calcining limestone), 3,900,434 (wallboard tape joint composition comprised of limestone), 4,015,973 (limestone-expanding clay granules), 4,026,7632 (use of ground limestone as a filler in paper), 4,231,884 (water retardant insulation composition comprising treated low density granular material and finely divided limestone), 4,237,025 (product comprising lime or limestone and Graham's salt), 4,239,736 (method for increasing the brightness of limestone), 4,272,498 (process for comminuting and activating limestone by reaction with carbon dioxide), 4,316,813 (limestone-based sorbent agglomerates), 4,390,349 (method for producing fuel gas from limestone), 4,430,281 (process for palletizing limestone fines), 4,594,236 (method of manufacturing calcium carbide from limestone), 4,614,755 (protective coating composition comprising a blend of polyvinyl acetate, hydraulic cement, EVA, and limestone), 4,629,130 (process for preparing finely divided limestone), 4,671,208 (clay and limestone composition), 4,710,226 (fluidization of limestone slurries), 4,781,759 (limestone and clay traction aid) 4,824,653 (method of bleaching limestone), 5,228,895 (fertilizer and limestone product), 5,375,779 (process for grinding limestone to a predetermined particle size distribution), 5,908,502 (limestone filled Portland cements), and the like. The entire disclosure of each of these United States patents is hereby incorporated by reference into this specification.

Referring again to FIG. 1, and in step 12 thereof, limestone is mined. A description of this mining step, and some of the properties of the limestone produced by it, are presented at columns 9 through 11 of U.S. Pat. No. 7,651,559. The entire disclosure of such United States patent is hereby incorporated by reference into this specification.

It is preferred that the limestone so mined contain at least about 40 weight percent of calcium carbonate and, more preferably, at least about 60 weight percent of calcium carbonate. In one preferred embodiment, the limestone so mined contains at least about 70 (and more preferably at least about 80) weight percent of calcium carbonate. In another embodiment, the limestone contains at least about 85 weight percent of calcium carbonate. In another preferred embodiment, the limestone so mined contains at least about 90 weight percent of calcium carbonate and, more preferably, at least about 95 weight percent of calcium carbonate.

In one preferred embodiment, the mined limestone used in the roofing granules of this invention has a hardgrove grindability index (HGI) of less than about 70 and, more preferably, less than about 68. In another preferred embodiment, the hardgrove grindabilty index of the limestone is less than 60 and, more preferably, from about 55 to about 58.

The hardgrove grindability index is well known to those skilled in the art and is described, e.g., in the specification and the claims of U.S. Pat. Nos. 4,419,456 (method for the disposal of shot coke), 4,521,278 (method for producing needle coke), 5,007,987, 5,389,353, 5,882,377, 6,882,517, and the like. The entire disclosure of each of these United States patents is hereby incorporated by reference into this specification.

The test for determining the hardgrove grindability index is described in A.S.T.M. Standard Test D409-85 “Standard Test Method for Grindability of Coal by the Hardgrove-Machine Method.” This A.S.T.M. test is also described, e.g., in U.S. Pat. Nos. 4,420,445 (coal pellets production), 4,419,456, 6,083,289, 6,692,544, and the like. The entire disclosure of each of these United States' patents is hereby incorporated by reference into this specification.

In one embodiment, the limestoneused contains less than about 4 weight percent of magnesium and, more preferably, less than about 2 weight percent of magnesium.

In one preferred embodiment, the limestone mined contains less than 2 weight percent of acid insoluble products, such as silica, aluminum oxides, iron oxides. In one aspect of this embodiment, the limestone mined contains less than 1.5 weight percent of acid insoluble product(s). It is preferred that the limestone contain less than about 1 weight percent of silica and less than 0.5 weight percent of aluminum oxide material and/or iron oxide material.

In one embodiment, the ore used in the process of this invention is dolomite.

Dolomite is a carbonate of calcium and magnesium that may be represented by the formula CaMg(CO₃)₂. This carbonate mineral has a hexagonal symmetry and a structure similar to that of calcite, but with alternate layers of calcium ions being completely replaced by magnesium. See, e.g., page 568 of Sybil P. Parker's “McGraw-Hill Dictionary of Scientific and Technical Terms,” Fourth Edition (McGraw-Hill Book Company, New York, N.Y., 1989).

In one preferred embodiment, dolomitic limestone is used to make applicants' shingle assembly.

Referring again to FIG. 1 and in step 14 thereof, the limestone from step 12 that preferably has the required degree of hardgrove grindability is subjected to crushing (in step 14) and screening (in step 18). The crushing step is discussed at lines 15 through 64 of column 12 of U.S. Pat. No. 7,651,559; the screening step is discussed at columns 12 through 14 U.S. Pat. No. 7,651,550; the entire disclosure of such patent is hereby incorporated by reference into this specification.

Referring again to FIG. 1, and in one preferred embodiment; ⅛″ crushed ore from step 14 is fed to drying step 16 in which it is dried to a moisture content of less than about 1 weight percent and, preferably, to less than about 0.1 weight percent. It is preferred to use a rotary dryer to effectuate such drying. These dryers are described, e.g., on pages 20-32 to 20-44 Perry and Chilton's “Chemical Engineers' Handbook,” Fifth Edition (McGraw-Hill Book Company, New York, N.Y., 1973). It is preferred to use a temperature of at least about 220 degrees Fahrenheit in the rotary dryer in order to vaporize all of the water in the ore so that it is “bone dry” (i.e., it contains less than about 0.1 weight percent of water).

The dried material from step 16 is then screened in step 18. In is preferred to utilize a multiplicity of multiple deck screeners, such as, e.g., four multiple deck screeners, in such step 18.

Multiple deck screeners are well known to those skilled in the art; reference may be had to U.S. Pat. No. 5,341,939, the entire disclosure of which is hereby incorporated by reference into this specification. One preferred multideck screener is the “Multi-Vib Screener” sold by Midwestern Industries, Inc. of Masillon, Ohio.

In the embodiment depicted in FIG. 1, a series of at least four multiple deck screeners (not shown) each will have an 8 mesh screen (2.38 millimeter sieve openings), a 10 mesh screen (1.68 millimeter openings), an 18 mesh screen, a 32 mesh screen (500 micron openings), and a 40 mesh screen. These screeners thus produce, e.g., a 10×18 feed (i.e., a feed that passes through the 10 mesh screen but is retained on the 18 mesh screen), an 18×32 feed (i.e., a feed that passes through the 18 mesh screen but is retained on the 32 mesh screen), a 32×40 feed, etc.

The 8×10 output from the multiple deck screeners can either be utilized as a non-headlap product and/or recycled in whole or in part. When it is to be recycled, it may be crushed again in one of the crushers (such as, e.g., the fourth crusher) and then fed again to one or more of the multiple deck screeners.

The other outputs from the different multiple deck screeners may be fed to bin 20 (“bin 1”), bin 22 (“bin 2”), bin 24 (“bin 3”), and/or bin 24 (“bin 4”), and the output from one or more of these bins may then be combined in step 28 and/or subject to “superfine air classification” in step 30 in order to produce the desired particle size distribution.

In the embodiment depicted in FIG. 1, different feeds from the multideck screeners and/or different combinations of feeds and/or different amounts of the feeds are fed to each of the bins 20, 22, 24, and 26 so that, when the material in these bins is combined and/or further purified (in turbine classification step 30), the desired particle size distribution will be obtained. There are a substantial number of combinations of conditions that will produce the desired particle size distribution. For any particular feed stock (such as, e.g., the 18/32 feedstock), one may feed some, all, or none of such feed stock to bin 20 and/or bin 22 and/or bin 24 and/or bin 26. One may, e.g., feed material from bin 20 and/or bin 22 and/or bin 24 and/or bin 26 to the turbine classification step 30 prior to the time such material is combined in step 28.

In one embodiment, the particle size of the material used in the process varies from 10 mesh (2000 microns) to 35 mesh (500 microns).

In another embodiment, at least about 90 weight percent of the particles have a maximum dimension within the range of from about 420 microns to about 2000 microns.

In another embodiment, the material has a particle size distribution such that from about 2 to about 10 weight percent of the particles are retained on a 12 mesh (1680 micron) screen, and/or from about 23 to about 50 weight percent of the particles are retained on a 16 mesh (1190 microns) screen, and/or from about 48 to about 77 weight percent of the particles are retained on a 20 mesh (840 microns) screen, and/or from about 80 to about 95 weight percent of the particles are retained on a 30 mesh (590 microns) screen, and/or from about 98 to about 99.5 weight percent of the particles are retained on a 40 mesh (420 microns) screen.

In one embodiment, less than 2 weight percent of the particles are smaller than 420 microns (40 mesh), and less than 10 weight percent of the particles are larger than 1700 microns.

In one embodiment, not shown, a controller (not shown) is operatively connected to laboratory 32 and, additionally, bin 20, bin 22, bin 24, bin 26, mixer 38, and classifier 30. By analyzing and monitoring the material present in each of these locations, the controller can modify the feeds from the multideck screeners and/or from the bins 20, 22, 24, and 26 and/or from the turbine classifier 30 to insure that the material discharged via line 34 from the turbine classifier has the desired particle size distribution.

Referring again to FIG. 1, in one embodiment, each of the multideck screeners (not shown) comprises a 4 mesh screen, an 11 mesh screen, and 18 mesh screen, a 24 mesh screen, and a 32 mesh screen.

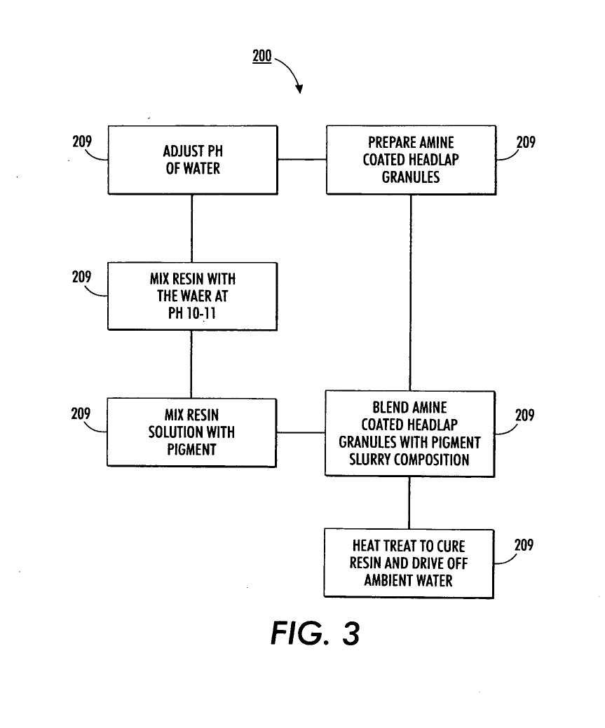

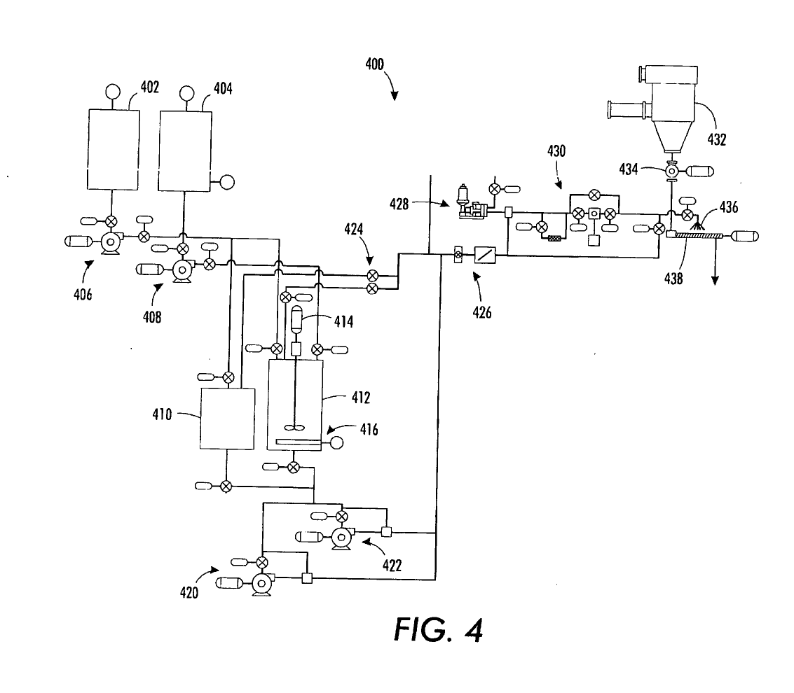

In one embodiment, the material retained on the 18 mesh screen may be coated with pigment and/or adhesion promoting agent (as is described elsewhere in this specification) and used to prepare headlap particles. The pigment coating process is described in FIG. 3; and the adhesion promoting agent process is described in FIG. 4.

In one embodiment, some or all of the material retained on the 32 mesh screen may be “classified” in the superfine turbine classification step 30 to produce a coarse fraction that also may be used in headlap production and a fine fraction that may either be discarded or used to produce other products.

Referring again to FIG. 1, some or all of the material fed to bins 20, 22, 24, and 26, either before or after they are combined in step 28, may be fed to a superfine turbine classifier in step 30. In such step 30, the feed(s) are subjected to air flow classification in order to reduce the concentration of fines” in such feed(s). Thus, e.g., the concentration of particles smaller than 250 microns may be reduced in such step 30.

Airflow separators are well known to those skilled in the art, and they are referred to in the claims of U.S. Pat. Nos. 5,541,831 (computer controlled separator device), 5,943,231 (computer controlled separator device), 6,351,676 (computer controlled separator device), and the like. The entire disclosure of each of these United States patents is hereby incorporated by reference into this specification.

Air flow separators are also discussed in U.S. Pat. Nos. 3,772,857 (water air separator), 3,874,444 (duo-baffle air separator apparatus), 3,877,454 (air separator), 3,962,072 (air separator apparatus), 4,662,915 (powder air separator), 4,824,559 (rotary air separator), 5,244,481 (vertical air separator), 5,788,727 (centrifugal air separator), 6,053,967 (air separator), 6,664,479 (method and air separator for classifying charging material reduced in size), and the like.

In one preferred embodiment, the air flow separator is a 72 inch “SuperFine Air Classifier” manufactured by Sturtevant, Inc. of 348 Circuit Street, Hanover, Ma.

Referring again to FIG. 1, and to the preferred embodiment depicted therein, the material fed from the air flow separation step 30 via line 34 preferably ranges in particle size from about 100 to about 2,500 microns, with at least 60 weight percent of the particles having sizes in the range of from about 600 to about 1400 microns. In one embodiment, at least about 70 weight percent of the particles have sizes in the range of from about 600 to about 1400 microns. In another embodiment, at least about 80 weight percent of the particles have sizes in the range from about 600 to about 1400 microns. In yet another embodiment, at least about 85 weight percent of the particles have sizes in the range of from about 600 to about 1400 microns.

In one embodiment, the material fed from airflow separator 34 (via line 38) ranges in particle size from about 500 to about 2500 microns (and, more preferably, from about 500 to about 2,000 microns). The airflow separator 30 preferably reduces the “fines content” of the particle compact so that the output in line 34 contains less than about 4 weight percent of particles smaller than 250 microns (60 mesh) and, more preferably, less than about 3 weight percent of particles smaller than 250 microns. In one embodiment, the material fed via line 34 contains less than 2 weight percent of material smaller than 250 microns and, more preferably, less than about 1 weight percent of material smaller than about 250 microns. In one embodiment, the material fed via line 34 contains less than about 0.4 weight percent of material smaller than 250 microns.

In one embodiment, the material fed from airflow separator 30 contains at least 95 weight percent of particles smaller than 3,350 microns.

In one embodiment, the material fed from air flow separator 30 contains at least 95 weight percent of particles smaller than 2,360 microns.

In one embodiment, the material fed from airflow separator 30 contains at least 95 weight percent of particles smaller than 1,700 microns.

In one embodiment, the material fed from airflow separator 30 contains at least 60 weight percent of particles smaller than 1,000 microns.

In one embodiment, the material fed from airflow separator 30 contains at least 30 weight percent of particles smaller than 850 microns.

In one embodiment, the material fed from airflow separator 30 contains at least 3 weight percent of particles smaller than 600 microns.

In one embodiment, the material fed from airflow separator 30 contains at least 97 weight percent of particles greater than 425 microns.

In one embodiment, the material fed from airflow separator 30 contains at least 98 weight percent of particles greater than 300 microns.

In one embodiment, the material fed from airflow separator 30 contains at least 98 weight percent of particles greater than 250 microns.

In one embodiment, the material fed from airflow separator 30 contains at least 99 weight percent of particles greater than 212 microns.

In one embodiment, the material fed from airflow separator 30 contains at least 99.5 weight percent of particles greater than 180 microns.

In one embodiment, the material fed from airflow separator 30 (via line 34) contains at least 97 weight percent of material greater than 30 mesh (with an average of 97.4 weight percent material greater than 30 mesh), at least 99 weight percent of material greater than 40 mesh (with an average of 99.07 weight percent greater than 40 mesh), at least 99 weight percent of material greater than 60 mesh (with an average of 99.55 weight percent greater than 60 mesh), and at least 99 weight percent of material greater than 100 mesh (with an average of 99.73 weight percent greater than 100 mesh). In one aspect of this embodiment, the material fed via line 34 contains from about 2 to about 6.5 weight percent of material greater than 12 mesh (with an average of 4.15 weight percent greater than 12 mesh), from about 35 to about 63 weight percent of material greater than 16 mesh (with an average of 45.77 weight percent greater than 16 mesh), and from 69 to 94 weight percent greater than 20 mesh (with an average of 78.95 weight percent greater than 20 mesh).

In another embodiment, the material fed from classifier 30, via line 24, contains from about 98.0 to 99.9 weight percent of particles smaller than 10 mesh (1700 microns), from about 93.5 to about 97.5 weight percent of particles smaller than 12 mesh (1400 microns), from about 38 to about 60 weight percent of particles smaller than 1000 microns, from about 5 to about 20 weight percent of particles smaller than 850 microns, from about 0.5 to about 6 weight percent of particles smaller than 600 microns, from about 0.1 to about 1.8 weight percent of particles smaller than 425 microns (40 mesh), and from about 0.04 to about 1.2 weight percent of particles smaller than 250 microns.

Referring again to FIG. 1, and to the preferred embodiment depicted therein, a portion of the material produced in airflow separator may be periodically withdrawn via line 33 to laboratory 32, in order to test the particle size distribution of such material; similarly, material may be withdrawn from mixer 28 to lab 32. The particle size analysis may be conducted by conventional means.

Referring again to FIG. 1, two mixers (mixer 36 and mixer 38) are shown in the preferred embodiment depicted. In this embodiment, mixer 36 is preferably used to add pigmented coating material to the mineral composition, and it is preferably used on darkened headlap material. In any event, it is preferred to feed all of the mineral composition material first to mixer 38 and add (in one embodiment) adhesion promoter material in mixer 38.

Referring again to FIG. 1, the material fed via lines 34 to mixers 38 and 36 preferably has the desired particle size distribution and, in one embodiment, a distribution modulus of from about 0.08 to about 0.14. If either or both of these values are not as desired, they may be adjusted by adding to mixer 36 (via line 35) more particulate material. After such addition, and appropriate mixing, sampling of the material in mixer 36 may occur in laboratory 32, and the process may be repeated until the desired values have been obtained.

The “distribution modulus” may be determined in accordance with conventional means. Thus, e.g., U.S. Pat. No. 6,323,269, the entire disclosure of which is hereby incorporated by reference into this specification, describes (in claim 1 thereof) “1. A mineral-containing thermoplastic granule for incorporation in a thermoplastic material to produce a thermoplastic end product, the granule comprising 85% to 92% by weight of an inorganic particulate material having a particle size distribution in accordance with the equation: cumulative percent finer than D=(Dn−DSn)/(D1n−DSn)·100, where D=particle size, DS=smallest particle size and is in the range of 10 to 0.1 μm, D1=largest particle size and is in the range of 100 to 1.0 μm, and n=distribution modulus . . . ” By determining the “cumulative percent finer than” (“D” or “CPFT”) for the material, the smallest particle size for the material, and the largest particle size for the material, one may readily determine the distribution modulus (n).

Referring again to FIG. 1, once the desired particle size distribution in mixer 36 has been obtained, and after such particles have preferably been pretreated with a pigmented material, one may pass such particles to mixer 38 in which one may add a mixture of oil and antistrip agent via line 39 to coat the inorganic particles in such mixer.

In one embodiment, the particles are not pretreated with a pigmented material; and the untreated particles are coated with an organic material (such as, e.g., a hydrocarbon oil like naphthenic mineral oil) but not with the amine agent. In another embodiment, the untreated material is coated with both the organic material and the amine agent.

Alternatively, one may add either the oil alone, or the antistrip agent alone, or neither the oil nor the antistrip agent. The goal, in one embodiment, is to produce a coating on such particulate matter with a thickness of from about 200 to about 2000 nanometers and, preferably from about 300 to about 1200 nanometers. The goal, in another embodiment, is to produce a material wherein the additive(s) is substantially absorbed into the pores of the particles being treated and produces a “coating” with no or with minimal thickness.

Treating the Particles with a Pigmented Material

In one preferred process, headlap granules are prepared that have one or more of the properties described elsewhere in this specification and, in addition, in one embodiment thereof, optionally contain a tinting agent that preferably comprises a pigment and a binder.

Claim 1 of U.S. Pat. No. 7,651,559, the entire disclosure of which is hereby incorporated by reference into this specification, describes, in part, a pigmented material that is comprised, in part, of from about 10 to about 35 weight percent of pigment and from about 90 to about 65 weight percent of a resin (see claim 1). The preparation of this pigmented material, and of the pigments, tinting agents, and resins, are described in columns 38 to 43 of such patent.

In one embodiment, the headlap granules preferably comprise at least about 0.1 weight percent of the tinting agent and, more preferably, from about 0.1 to about 0.8 weight percent of such tinting agent. In one aspect of this embodiment, the headlap granules comprise from about 0.1 to about 0.6 weight percent of the tinting agent. In another aspect of this embodiment, the headlap granules comprise from about 0.15 to about 0.45 weight percent of the tinting agent. In yet another aspect, from about 0.2 to about 0.4 weight percent of the tinting agent is present in the headlap granules.

In one aspect of this embodiment, the tinting agent is present as a coating on the surfaces of the headlap granules; preferably the coating has a thickness of from about 5 to about 15 microns.

In one embodiment, the tinting agent is comprised of from about 10 to about 35 weight percent of a pigment; in another embodiment, the tinting agent is comprised of from about 10 to about 20 weight percent of a pigment. Suitable pigments that may be used are described in column 39 and 40 of U.S. Pat. No. 7,651,559.

In one preferred embodiment, the inorganic pigment is carbon black. In one aspect of this embodiment, a mixture of carbon black and a resin is prepared by conventional means.

The resin used is preferably a synthetic resin that, e.g., is a film-forming synthetic resin; and processes for preparing mixtures of such synthetic resin and carbon black are well known. Suitable synthetic resins that may be used, and suitable water-soluble resins that may be used, are described at columns 39 to 41 of U.S. Pat. No. 7,651,559.

The mixture of the resin and the carbon black may be prepared by conventional means. Reference may be had, e.g., to U.S. Pat. Nos. 3,557,040 (process for preparing a carbon black-synthetic resin composition), 3,563,916 (carbon-black-synthetic resins electro-conductive composition), 3,833,541 (molding powder of aggregates containing carbon black embedded in matrix of vinyl chloride-acetate resin and heat stabilizer), 3,925,301 (process for the continuous production of carbon black-synthetic resin concentrates), 4,379,871 (process for the production of carbon black containing pigment-synthetic resin concentrates), 4,442,160 (electrostatic recording medium having an electrically conductive layer containing pre-dispersed electrically conductive carbon black and polyurethane binder resin), 4,683,158 (carpet having bottom portions of pile covered with carbon back containing resin), 4,734,450 (polypropylene-based resin composition containing an inorganic filer and 0.01 to 0.6 weight percent of carbon black), 5,041,473 (process for producing carbon black filled polyethylene resins), 5,207,949 (highly conductive polyoxymethylene resin composition containing carbon black), and the like. The entire disclosure of each of these United States patents is hereby incorporated by reference into this specification.

The tinting agent preferably contains from about 10 to about 35 weight percent of pigment (such as, e.g., carbon black), and from about 90 to about 65 weight percent of resin, both by combined weight of pigment and resin. In one embodiment, the tinting agent contains from about 10 to about 20 weight percent of pigmentand from about 90 to about 80 weight percent of resin.

In one embodiment, the tinting agent is made from a water soluble resin and carbon black by the process depicted in FIG. 3. Referring to FIG. 3, and to the process 200 depicted therein, in step 202 the pH of the water used in the process is adjusted so that it is from about 10 to about 11 and, more preferably about 10.3 to about 10.7. A sufficient amount of water may be charged to a container (such as, e.g., a beaker) so that when the resin is thereafter charged to the container it will contain from about 20 to about 50 parts of resin, by total weight of resin and water.

One may add ammonia to the water to adjust its pH. Alternatively, or additionally, one may add other pH increasing agents such as, e.g., sodium hydroxide, potassium hydroxide, etc.

Once the pH of the water has been suitably adjusted, one may charge water-soluble resin to the water. One may use one or more of the water-soluble resins known to those skilled in the art. Reference may be had, e.g., to columns 40 and 41 of U.S. Pat. No. 7,651,559.

In one embodiment, the resin used is an ester of pentaerythritol and rosin. These esters are well known and are disclosed, e.g., in U.S. Pat. No. 4,548,746, the entire disclosure of which is hereby incorporated by reference into this specification.

In one preferred embodiment, the resin used in a fumaric modified pentarythritol ester identified by Chemical Abstracts Registry number 68152-57-8 and sold as “Filtrez 521” by Hexion Specialty Chemicals Inc. of 1202 East Parker Street, Baxley, Ga. 31513.

Referring again to FIG. 3, and to step 204 thereof, the water-soluble curable resin is mixed with the water until it is completely dissolved. In one embodiment, from about 20 to about 50 parts of resin are mixed with about 80 to about 50 parts of water, both by weight. In another embodiment, from about 25 to about 40 parts of resin are mixed with from about 785 to about 60 parts of water. In yet another embodiment, about 30 parts of resin are mixed with about 70 parts of water.

The water used is preferably at ambient temperature, and the resin is added to the water, with stirring, and blended over a suitable period of, e.g., from about 10 to about 15 minutes. Thereafter, the solution this produced is mixed with the pigment to form a slurry. The pigment (such as, e.g., carbon black) is preferably slowly added and blended with the solution in step 206 until a substantially homogeneous slurry has been produced.

The substantially homogeneous slurry produced in step 206 is then blended with amine-coated headlap granules prepared in step 203. Referring again to FIG. 3, and to the preferred embodiment depicted therein, in step 207 the amine-coated limestone granules are coated with the slurry produced in step 206. It is preferred to coat the amine-coated limestone granules with slurry in the same manner (described elsewhere in this specification) in which the uncoated limestone granules were coated with amine, viz.—spraying the coating agent (in this case the slurry, in the prior case the amine) onto the limestone granules as such granules are being transferred through a blending screw. Alternatively, or additionally, other conventional coating processes may be used; thus, e.g., a nebulizing spray mixer may be used.

In this embodiment, the slurry-coated and amine-coated limestone granules are then heat treated in step 209, wherein they are subjected to a temperature of 130 degrees Centigrade for at least 15 minutes to drive off the water and to cure the tinting agent slurry. The product thus produced is substantially water insoluble.

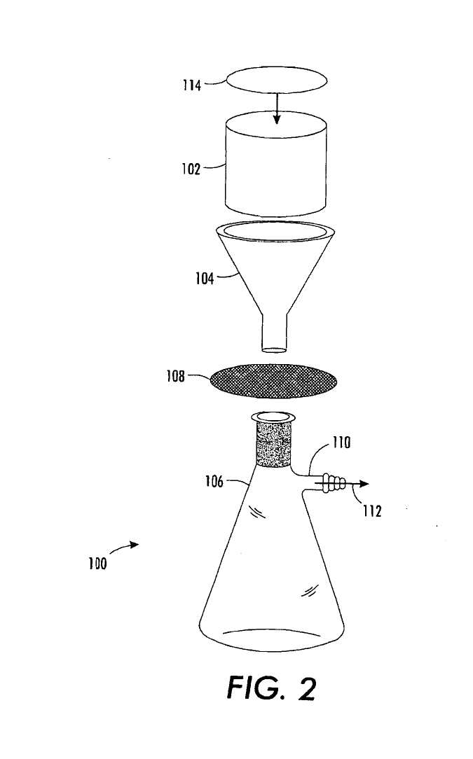

The solubility of the product produced in step 209 of FIG. 3 may be tested in accordance with a process in which 100 grams of such product are disposed in a 500 milliliter beaker to which 375 milliliters of water are then added, and the material is mixed and thereafter boiled for 2 hours. Thereafter, the material is inspected to determine the extent to which, if any, the tinting agent has been removed from the limestone granules. Any of the ink that has separated from the particles will produce turbidity in the water and/or floating black particles in the water and/or material stuck to the surface(s) of the beaker. It is preferred that less than about 5 weight percent (and, more preferably, less than about 1 weight percent) of the tinting agent be removed from the coated headlap granules by this test. This process is illustrated in FIG. 2 and is described in more detail in column 25 of U.S. Pat. No. 7,651,559, the entire disclosure of which is hereby incorporated by reference into this specification.

### Preferred Adhesion Improving Additives

In U.S. Pat. No. 7,651,559, the entire disclosure of which is hereby incorporated by reference into this specification, certain “Preferred Adhesion Improving Additives” are discussed in the disclosure beginning at line 36 of column 16 and extending through line 18 of column 23 of such patent. These adhesion improving additives may be used in the process of the present invention, and they are more briefly described hereinbelow.

FIG. 3 refers to some of these adhesion improving additives in step 209 thereof (“amine coated headlap granules”). FIG. 4 also optionally utilizes one of these additives (“amine antistrip agent” in its supply tank 404.

### Suitable Adhesion Improving Additives

One may use the adhesion improving additives known to those skilled in the art in, e.g., the process 400 depicted in FIG. 4.

By way of illustration, one may use the adhesion improving additives disclosed in U.S. Pat. Nos. 4,038,102 (an ether amine), 4,721,159 (the reaction product of an amine antistrip and an acid salt), 5,064,571 (mixtures of amido-amines), 6,290,772 (hydroxylamines), 6,503,740 (organic modifiers), 6,786,963 (diamide compounds), 6,875,341 (antistrip agents), and the like. The entire disclosure of each of these United States patents is hereby incorporated by reference into this specification.

By way of yet further illustration, one may use one or more of the agents disclosed in U.S. Pat. Nos. 4,839,404 (bituminous compositions having high adhesive properties), 4,933,384 (bituminous materials), 4,975,476 (bituminous materials), 5,352,275 (method of producing hot mix asphalt), 5,558,702 (asphalt emulsions containing amphoteric emulsifier), 5,566,576 (asphalt emulsions), 5,660,498 (patching system and method for repairing roadways), 5,667,577 (filled asphalt emulsions containing betaine emulsifier), 5,755,865 (asphalt rejuvenator and recycled asphalt composition), 5,766,333 (method for recycling and rejuvenating asphalt pavement), 6,093,494 (antistrip latex for aggregate treatment), 6,403,687 (antistrip latex for aggregate treatment), and the like. The entire disclosure of each of these United States patents is hereby incorporated by reference into this specification.

In one preferred embodiment, the agent to be used is an organic amine, which may be primary, secondary, or tertiary, and which contains from about 1 to about 18 carbon atoms.

In one preferred embodiment, the agent is an amido-amine (fatty acid amine).

In one preferred embodiment, the agent is comprised of 4,4′-methylenebiscyclohexanamine. In another embodiment, the agent is comprised of mixed polycycloaliphatic amines.

In one preferred embodiment, in addition to or instead of the amine agent, one may use an adhesion-promoting agent, such as, e.g., the adhesion agents described in U.S. Pat. No. 5,240,760, the entire disclosure of which is hereby incorporated by reference into this specification.

These adhesion improving additives, and others, are discussed in columns 16 through 23 of U.S. Pat. No. 7,651,559, the entire disclosure of which is hereby incorporated by reference into this specification.

In the embodiment depicted in FIG. 1, the adhesion improving additive and/or the preferred oil is preferably mixed in mixer 36 with the particulate material (from line 34). In one embodiment, the use of the amine agent is omitted, and only the oil is applied as a coating. In another embodiment, the use of the oil is omitted, and only the amine agent is applied as a coating. In yet another embodiment, neither such oil nor such amine agent is utilized.

In this embodiment, the oil used may be, e.g., a “hydrocarbon oil,” as that term is defined in U.S. Pat. No. 6,358,305, the entire disclosure of which is hereby incorporated by reference into this specification. At column 4 of U.S. Pat. No. 6,358,305, certain “hydrocarbon oils” are described; one or more of these “hydrocarbon oils” may be used in conjunction with the amine agent described elsewhere in this specification (or by itself) to prepare coated limestone granules. At lines 47-54 of such column 4, it is disclosed that, “The hydrocarbon oils employed in the compositions of the present invention may be either synthetic or natural in origin. These oils, referred to as process oils, can be obtained from petroleum, coal, gas and shale. The oils are of the lubricating oil viscosity range, typically in a 300 c.p. viscosity range. These hydrocarbon oils are often referred to as process oils and are available from several companies, such as Ergon Inc., Arco and Cross Oil Co.”

The hydrocarbon oil used may be, e.g., one or more naphthenic mineral oils, and/or a paraffinic mineral oil, and/or a plant oil, and/or an animal oil

Naphthenic mineral oils are preferred in one embodiment. They contain a significant proportion of naphthenic compounds, and they are well known to those skilled in the art. Reference may be had to the following United States patents which refer to “naphthenic mineral oil” in their claims: 3,980,448 (organic compounds as fuel additives), 4,101,429 (lubricant compositions), 4,180,466 (method of lubrication of a controlled-slip differential), 4,324,453 (filling material for electrical and light waveguide communications cables), 4,374,168 (metalworking lubrication), 4,428,850 (low foaming lubricating oil compositions), 4,510,062 (refrigeration oil composition), 4,676,917 (railway diesel crankcase lubricant), 4,720,350 (oxidation and corrosion inhibiting additives for railway diesel crankcase lubricants), 4,793,939 (lubricating oil composition containing a polyalkylene oxide additive), 4,781,846 (additives for aqueous lubricant), 5,460,741 (lubricating oil composition), 5,547,596 (lubricant composition for limited slip differential of a car), 5,658,886 (lubricating oil composition), 6,063,447 (process for treating the surface of metal parts), 6,245,723 (cooling lubricant emulsion), 6,482,780 (grease composition for rolling bearing), 6,736,991 (refrigeration lubricant for hydrofluorocarbon refrigerants), and the like. The entire disclosure of each of these United States patents is hereby incorporated by reference into this specification.

When both the oil and the amine agent are used, it is preferred that the ratio of the oil/amine agent used is from about 10/90 to about 90/10 weight percent. In one embodiment, from about 0.25 to about 1.0 pounds of such oil is added for each 2,000 pounds of the limestone granules in mixer 45. In another embodiment, from about 0.25 to about 1.0 pounds of a mixture of such oil and one or more of the aforementioned amine agent is added for each 2,000 pounds of the limestone granules in mixer 45.

In another embodiment, from about 1 to about 3 parts of oil are preferably used for each part of the amine compound. In one aspect of this embodiment, from about 1.5 to about 2.5 parts of oil are used for each part of the antistrip compound.

In one embodiment, from about 0.5 to about 2.0 gallons of such oil, and from about 0.5 to about 1.0 gallons of such adhesion improving agent are added for each ton of the limestone granules.

In one embodiment, a sufficient amount of oil and/or adhesion improving agent is charged via line 39 to form a coating on the particulate matter in mixer 38 that is from about 200 to about 2,000 nanometers and, preferably, from about 300 to about 1200 nanometers; and, within such mixer, it preferably is sprayed onto the particulate matter in the manner described elsewhere in this specification.

In one preferred embodiment, a blend of the oil and the amine compound, or the oil itself without any amine compound, is sprayed onto the limestone granules (from “line 40”) as such granules are being transferred through a blending screw. The rate of addition is preferably based on the rate of the atomizer as it relates to the rate of the material being transferred through the blending screw.

Spraying the Additive onto the Granular Particles

In one embodiment, the additive used is naphthenic mineral oil, it acts as an adhesion improving agent, and such oil is preferably in a liquid form that is sprayed onto the particles. If such oil is not in a liquid phase, it is converted to a liquid phase prior to the time it is sprayed onto the granular material.

As used herein, the term “sprayed” includes the term “nebulized,” and it refers to any process step in which the oil additive is formed into an aerosol of fine droplets before they are applied to the surfaces of the particles being coated. Without wishing to be bound to any particular theory, applicants believe that, unless the oil is applied by spraying, the coated particles thus produced will not have adequate adhesion properties.

The additive may be sprayed by conventional methods such as, e.g., those described on pages 18-58 to 18-65 of Robert H. Perry et al.'s “Chemical Engineers Handbook,” Fifth Edition (McGraw Hill Book Company, New York, N.Y., 1973).

Thus, e.g., and as is disclosed in the Chemical Engineers Handbook, one may use spray nozzles such as, e.g., the nozzles illustrated in FIG. 18-112 and Table 18-21 of such handbook.

One may use the nebulizer described in U.S. Pat. No. 6,705,312, the entire disclosure of which is hereby incorporated by reference into this specification. This patent describes a device that has a main body containing a vibrating element, electronic circuitry, and battery for powering the circuitry and the vibrating element. An atomiser is provided on top of the main body, and is suitably coupled to the electronic circuitry and the vibrating element to allow for atomisation of liquid.”

One may use the spraying process described in U.S. Pat. No. 6,966,610, the entire disclosure of which is hereby incorporated by reference into this specification. As is disclosed in such patent, “the spraying may be carried out by the use of a spray gun for example Hot Shot Adhesive gun available from Sericol Limited of the United Kingdom which uses compressed air at up to 10 bar and preferably from 5 to 7 bar . . . . Power HB 600 spray melt, a spray gun available from Power Adhesives Limited of the United Kingdom is also suitable for use in the present invention. The gun uses compressed air at up to 8 bar heated to 70 to 250° C. . . . . The spraying may conveniently be carried out using a hand held spray gun provided with an electrically heated compartment for the adhesive and means for supplying air under pressure to the molten adhesive to assist the spraying. Instead of the gun being hand held the adhesive may be automatically applied using an automatic spray gun or other applicators.”

One may use a nebulizer such as, e.g., the ultrasonic nebulizer described in U.S. Pat. No. 7,673,812, the entire disclosure of which is hereby incorporated by reference into this specification. Claim 1 of this patent describes: “1. A portable ultrasonic nebulizer apparatus for automatically adjusting an operation frequency of the apparatus corresponding to a resonant frequency, comprising: a power supply for supplying power; vibrating element to vibrate a liquid to form an aerosol of fine droplets; a variable oscillator for providing a plurality of frequencies to the vibrating element so as to let the vibrating element vibrates at the plurality of frequencies; a step-up converter electrically connected with the variable oscillator for converting an input voltage to a boosted voltage to the vibrating element; a current detecting element positioned between the power supply and the vibrating element for detecting a plurality of electrical current values passing before the vibrating element, the value being respectively related to each of the plurality of frequencies; and a microprocessor for receiving the plurality of electrical current values related to each of the plurality of frequencies so as to determine the resonant frequency at which the electrical current is a maximum value and adjusting the operation frequency of the vibrating element provided by the variable oscillator corresponding to the resonant frequency.”

One may spray the additive onto the limestone granules by the process described in U.S. Pat. No. 7,611,753, the entire disclosure of which is hereby incorporated by reference into this specification. Claim 1 of this patent discloses: “1. A process comprising impregnating a porous mineral substrate with a liquid impregnating agent, wherein the impregnating comprises spraying the liquid impregnating agent and a gas from a gas-supported spraying assembly; and the liquid impregnating agent is sprayed from the gas-supported spraying assembly at a pressure of at most 2 bar gauge, wherein the gas-supported spraying assembly comprises a nozzle system comprising one or more nozzles; the liquid impregnating agent and the gas are fed into each of the one or more nozzles at a pressure of at most 2 bar gauge; and the gas atomizes the liquid impregnating agent in each of the one or more nozzles, wherein the liquid impregnating agent is substantially free of solvent.”

One may deposit the additive onto the limestone granules by means of the ultrasonic fog generator described in U.S. Pat. No. 7,810,742, the entire disclosure of which is hereby incorporated by reference into this specification. Claim 1 of this patent describes: “1. An ultrasonic fog generator comprising: a container comprising therein an ultrasonic nebulizer and a liquid, said ultrasonic nebulizer operative to vibrate at very high frequencies and thereby break down the liquid into a fog comprising tiny vapor particles, said container having an exit opening for said fog to pass therethrough; a driver and a driving fluid, said driver being operative to cause said driving fluid to flow past the exit opening and draw out said fog through the exit opening without said driving fluid substantially entering said container, wherein said driver is positioned facing a closed rear face of said container and said exit opening is positioned on a front face of said container opposite said rear face, wherein said front face of said container comprises a wall extending from side faces of said container, and said exit opening is formed through said wall.”

One may deposit the additive onto the limestone granules by means of the plasma spraying device disclosed in published United States patent application 20080057212, the entire disclosure of which is hereby incorporated by reference into this specification. Claim 1 of this published patent application describes: “1. Plasma spraying device for spraying a coating (2) onto a substrate (3) by a thermal spray process, said plasma spraying device including a plasma torch (4) for heating up a plasma gas (5) in a heating zone (6), wherein the plasma torch (4) includes a nozzle body (7) for forming a plasma gas stream (8), said plasma torch (4) having an aperture (9) running along a central longitudinal axis (10) through said nozzle body (7), which aperture (9) has an convergent section (11) with an inlet (12) for the plasma gas (5), a throat section (13) including a minimum cross-sectional area of the aperture, and a divergent section (14) with an outlet (15) for the plasma gas stream (8), wherein an introducing duct (16) is provided for introducing a liquid precursor (17) into the plasma gas stream (8), characterized in that a penetration means (18, 161, 181, 182) is provided to penetrate the liquid precursor (17) inside the plasma gas stream (8).”

One may deposit such additive onto the limestone granules by means of the heated nebulizer device disclosed in published United States patent application 20100258114, the entire disclosure of which is hereby incorporated by reference into this specification. Claim 1 of this published patent application describes: “1. A nebulizer assembly comprising: a reservoir for containing a liquid; a nebulizer for producing an aerosolized gas using the liquid; an aerosolized gas outlet coupled to the nebulizer to pass the aerosolized gas; and a heating chamber disposed around an exterior of the reservoir, wherein the heating chamber includes a heating fluid inlet in fluid communication with the heating chamber for providing heating fluid to the heating chamber and a heating fluid outlet in fluid communication with the heating chamber for discharging the heating fluid from the heating chamber.”

In one embodiment, the additive is heated to a temperature greater than ambient prior to the time it is sprayed onto the granular material. In another embodiment, the granular material is heated a temperature greater than ambient prior to the time the additive is sprayed onto it. In either case, it is preferred to agitate the granules during spraying in order to expose as many granular surfaces as possible to the spray.

In one embodiment, and referring again to FIG. 1, from about 0.001 to about 4 parts (by weight) of such oil, and from about 0.001 to about 4 parts (by weight) of such amine agent, are charged to mixer 38 for each 100 parts of particulate in such mixer.

In one embodiment, the oil and the amine agent are preferably mixed in mixer 38 which, in one aspect of this embodiment, is comprised of a blending screw. Samples may be periodically withdrawn from the mixer 38 via line 42 to be tested in laboratory 32 and to determine whether the coated particles have met the specifications for the roofing granules.

In one aspect of this embodiment, the aforementioned amine agent and/or oil are charged to mixer 38 via line 39. In this embodiment, the particles from air flow separator 30 are charged directly via line 34 to mixer 38.

In another embodiment, illustrated in FIG. 1, the particles from air flow separator 30 are charged via line 34 to mixer 36, but a mixture of pigment and binder is added to mixer 36. The pigmented particles produced in mixer 36 are then charged via line 40 to mixer 38, wherein the amine agent and/or oil is added via line 39. Thereafter, the particles so treated are fed via line 44 to mass flow silo 46.

### Another Preferred Process of the Invention

In one embodiment, the roofing granules of this invention are made in substantial accordance with the procedure described with reference to FIGS. 1 and 3, with several modifications.

In the first place, two mixers are used (see, e.g., “mixer 36” and “mixer 38” depicted in FIG. 1). It is preferred to charge the particles from air flow separator 30 to mixer 36 via line 34 and, while such particles are in such mixer, mix them with the pigment and binder mixture described in this specification. In one aspect of this embodiment, the amine agent and/or the oil are not charged to mixer 36 but are thereafter charged to mixer 38. Thus, the difference in this new embodiment is that the pigment and binder mixture are charged and mixed with the particles prior to the time they are contacted with either the amine adhesion improving agent and/or the oil.

In one aspect of this embodiment, the mixer 36 is heated such that, during the mixing of the particles with the pigment/binder mixture, such particles are preferably heated to a temperature of at least about 130 degrees Celsius for at least about 15 minutes. In one aspect of this embodiment, such particles are heated to a temperature of at least about 130 degrees Celsius for at least about 22 minutes.

In this embodiment, one may use the same pigments and/or binders as has been described elsewhere in this specification. Alternatively, one may replace some or all of the binder described hereinbefore with a film forming binder.

As is known to those skilled in the art, a film forming binder is a material that forms a polymeric surface which encapsulates the particles with which it is contact. Reference may be had, e.g., to U.S. Pat. Nos. 5,079,037 (resistive films comprising resistive short fibers in insulating film forming binder), 5,516,458 (coating composition containing film forming binder), and 6,096,835 (coating composition containing film forming binder). Reference also may be had to published United States patent applications US2003/013050 (coating composition containing polythiophene and film-forming binder) and US2005/0029496. The entire disclosure of each of such United States patents and published United States patent applications is hereby incorporated by reference into this specification.

In one embodiment, the mineral composition of this invention is coated with a film forming binder containing a pigment. The desired effect of this pigment-binder system is to coat the exposed surface of the granules where as the cured coating, surface is not readily stripped away by additional processing or by heating during processing.

When such film forming binder is used, it is preferred that to mix such binder with the pigment described elsewhere in this specification to produce a mixture that preferably comprises from about 15 to about 20 weight percent of such binder, from about 15 to about 20 weight percent of such pigment, and one or more solvents. The solvent used is preferably an aqueous solvent that comprises water.

In one embodiment, a pigment is used to produces a black color with certain L*a*b* values. These L*a*b* values may be measured using the “Lab color space system.”

As is known to those skilled in the art, “Lab” is the abbreviated name of two different color spaces, the best known of which is “CIELAB” (also referred to as “CIE 1976 L*a*b*”); and it is discussed at columns 44 and 45 of U.S. Pat. No. 7,651,559.

Referring again to FIG. 1, the binder, pigment, and water are preferably present in the form of an aqueous slurry, and such slurry is preferably sprayed onto the particles in mixer 36. In one embodiment, the mixer 36 preferably is comprised of nozzles through which the slurry may be sprayed as the particles are being tumbled.

In another embodiment, instead of using a slurry, the particles are treated with a lubricating oil and/or an amine agent.

During the tumbling/spraying process, it is preferred to subject the particles being so treated to a temperature of at least 130 degrees Celsius. It is also preferred to conduct the spraying operation so that a substantially homogeneous mixture of coated particles is produced. In one embodiment, the spraying, tumbling, and heating operations occur simultaneously for a period of at least 15 minutes.

In one embodiment, the coating produced on the particles, after drying, is applied at a coating weight of from about 0.25 to about 0.4 weight percent, by weight of uncoated particles.

Referring to FIG. 1, after the coated particles are prepared in mixer 36, they are then fed via line 40 to mixer 38, wherein the amine agent and/or the oil may be added in the manner described elsewhere in this specification. Thereafter, the treated particles may be fed via line 44 to mass flow silo 46.

### The Process 400 Illustrated in FIG. 4

FIG. 4 illustrates yet another process that may be used to make the headlap granules. FIG. 4 is a partial schematic of a process 400 for preparing coated headlap particles. Supply tank 402 contains oil such as, e.g., the napthenic mineral oil described elsewhere in this specification. Supply tank 404 also may contain amine agent such as, e.g., the amine adhesion improving agent disclosed elsewhere in this specification.

The oil used in supply tank 402 preferably has a viscosity, under ambient conditions, of from about 70 to about 300 centipoise and, more preferably, from about 80 to about 120 centipoise.

The oil from tank 402 is pumped by pump 406 to mixing tank 412. In the optional embodiment, the antistrip agent from tank 404 is pumped by pump 408 to mixing tank 412. The flow rates of these materials are adjusted so that the correct ratio of oil/antistrip agent is present in mixing tank 412. This ratio, in one embodiment, is from about 2.5 to about 3.5.

It is preferred to maintain a substantially homogeneous mixture of the oil and the amine adhesion improving agent in mixing tank 412 when both are to be used.

In order to maintain the mixture in tank 412 at the desired properties, the mixture is preferably continuously stirred with mixer 414 and heated with immersion heater 416.

The heated mixture from mixing tank 412 may be fed to coating pump 420 and/or coating pump 422. Oil from oil tank 410 may be added to the mixture that is fed to coating pump 420 and/or coating pump 422. Alternatively, or additionally, oil from oil tank 410 may be fed from coating pump 422, and the mixture may then be fed through valves 424 and 426 to coating screw 438.

In the embodiment Illustrated in FIG. 4, the heated mixture of oil and antistrip agent is fed through metering pump 428 and flowmeter assembly 430, and thereafter it is sprayed onto the coating screw 438 which is conveying particles of limestone from classifier 432. The limestone particles from classifier 432 are fed into airlock 434 and thence into the coating screw 438.

### The Moh's Hardness of the Coated Granules

In one embodiment, and referring again to the coated particles produced in mixer 36 of FIG. 1, the Moh's hardness of the coated particles is preferably from about 2.5 to about 3.5 and is often from about 2.9 to about 3.1. It should be noted that calcite, which is the predominant component of limestone, is 3.0 on the Moh's scale.

### The Adhesion of the Coated Granules

Applicants have discovered, as is shown by their Examples, that treatment of the headlap particles with either the organic additive (such as the hydrocarbon oil) alone and/or the amine additives increases the adhesion of the coated particles as long such additives are preferably sprayed onto the particles in the manner described in the preceding section of this specification.

In one preferred embodiment, the adhesion of the coated granules is tested in accordance with ASTM Standard test 4977-03. It is to be understood that, when reference is made to “adhesion loss as determined by ASTM Standard test 4977-3,” it is to be understood that such term refers to the adhesion loss of a shingle made in accordance with the specified procedure that has been subjected to the specified rub test. This rub test procedure is described elsewhere in this specification.

Without wishing to be bound to any particular theory, applicants believe that the product made in accordance with applicants' invention, involving spraying, will pass the rub test, but products not so made (wherein, e.g., the additive is mixed by conventional means but not sprayed) often will fail such test.

### pH of the Granules

In one embodiment, the pH of the coated particles in mixer 44 and/or 45 is from about 8 to about 11 and, more preferably, from about 9 to about 11.

### Preparation of a Roofing Shingle

Referring again to FIG. 1, and in one preferred embodiment depicted therein, in step 56 roofing shingles are prepared with the coated granules disposed in mass flow silo 52.

The roofing shingles may be made in accordance with the procedure described in U.S. Pat. Nos. 3,888,684, the entire disclosure of which is hereby incorporated by reference into this specification; alternatively, such shingle may be made in accordance with the procedure described elsewhere in this specification.

One may use the process disclosed in U.S. Pat. No. 4,274,243 to make the roofing shingle; the entire disclosure of this patent is hereby incorporated by reference into this specification. Claim 1 of this patent describes, “1. A method of forming a laminated roofing shingle comprising: (a) providing an indefinite length of asphalt-impregnated, felted material; (b) adhering a coating of mineral granules to at least one surface of said felted material; (c) cutting said material in a repeating pattern along the longitudinal dimension of said material so as to form an interleaved series of tabs of pairs of overlay members, each said tab, defined by said step of cutting, being of substantially identical shape and the lower edge of each said tab being defined by a smoothly curving negatively contoured edge; (d) making pairs of underlay members in a similar manner as above but wherein the lower edges of the underlay members are defined by a substantially continuously curving sinuous cut having a uniform periodic shape and amplitude such that each pair of underlay members thus formed are substantially identical; and (e) laminating said underlay members to said overlay members so as to form a series of shingles having substantially the same overall shape, wherein said step of laminating further includes the step of positioning said negatively contoured edge of each said tab directly over a substantially correspondingly curving portion of the lower edge of each said underlay member so as to simulate a series of alternating ridges and valleys of a portion of a tile covered roof.”

Asphalt is preferably used to making the roofing shingles. As is disclosed on page 71 of George S. Brady et al.'s “Materials Handbook,” Twelfth Edition (McGraw-Hill Book Company, New York, N.Y., 1986), asphalt is “A bituminous, brownish to jet-black substance, solid or semi-solid, found in various parts of the world. It consists of a mixture of hydrocarbons, is fusible and largely soluble in carbon disulfide. It is also soluble in petroleum solvents and turpentine. The melting points range from 32 to 38 degrees C. Large deposits occur in Trinidad and Venezuela. Asphalt is of animal origin, as distinct from coals of vegetable origin. Native asphalt usually contains much mineral matter; and crude Trinidad asphalat has a composition of about 47% bitumen, 28 clay, and 25 water. Artificial asphalt is a term applied to the bituminous residue from coal distillation mechanically mixed with sand or limestone.”

Asphalt is also described in the claims of various United States patents, such as, e.g., U.S. Pat. Nos. 3,617,329 (liquid asphalt), 4,328,147 (roofing asphalt formulation), 4,382,989 (roofing asphalt formulation), 4,634,622 (lightweight asphalt based building materials), 4,895,754 (oil treated mineral filler for asphalt), 5,217,530 (asphalt pavements), 5,356,664 (method of inhibiting algae growth on asphalt shingles), 5,380,552 (method of improving adhesion between roofing granules and asphalt-based roofing materials), 5,382,449 (method of using volcanic ash to maintain separation between asphalt roofing shingles), 5,511,899 (recycled waste asphalt), 5,516,573 (roofing materials having a thermoplastic adhesive intergace between coating asphalt and roofing granules), 5,746,830 (pneumatic granule blender for asphalt shingles), 5,776,541 (method and apparatus for forming an irregular pattern of granules on an asphalt coated sheet), 5,795,622 (method of rotating or oscillating a flow of granules to form a pattern on an asphalt coated sheet), 6,095,082 (apparatus for applying granules to an asphalt coated sheet to form a pattern having inner and outer portions), 6,358,319 (vacuum treatment of asphalt coating), 6,358,319 (magnetic method and apparatus for depositing granules onto an asphalt-coated sheet), 6,465,058 (magnetic method for depositing granules onto an asphalt-coated sheet), and the like. The entire disclosure of each of these United States patents is hereby incorporated by reference into this specification.

In the process of making a shingle, asphalt is preferably deposited onto a fibrous mat such as, e.g., a fiberglass mat. One may use any of the fiberglass mats described in the prior art in applicants' process. Thus, e.g., one may use the fiberglass mat described in U.S. Pat. No. 7,678,467, the entire disclosure of which is hereby incorporated by reference into this specification. Claim 1 of this patent describes: “1. An asphalt shingle comprising: an organic felt or fiberglass mat; a first layer of a chemically-modified, air-blown asphalt and a second layer of a chemically-modified, air-blown asphalt, wherein the mat is coated on its top surface by one of the layers of chemically-modified, air-blown asphalt and the mat is coated on its bottom surface by the other layer of chemically-modified, air-blown asphalt; and a surfacing material embedded into the surface, that is opposed to the mat, of at least one of the chemically-modified, air-blown asphalt layers; wherein said chemically-modified, air-blown asphalt is formed by a process for modifying an asphalt that comprises air blowing the asphalt and mixing polyphosphoric acid with the asphalt before the air blowing, during the air blowing, or a combination thereof to form the chemically-modified, air-blown asphalt.”

By way of further illustration, one may use the glass fiber mat disclosed in U.S. Pat. No. 6,993,876 (glass fiber mat comprised of an adhesion promoter and an organic resin binder), 6,817,152 (non-woven glass fiber mat comprised of polysiloxane), 6,706,147 (non-woven fiber mat comprised of a cured polysiloxane), 6,562,118 (cellulosic fiber mat), 6,384,116 (asphalt impregnated glass fiber mat), 5,865,003 (glass fiber mat comprised of portions with different binder concentrations), 5,851,933 (glass fiber mat treated with a modified urea formaldehyde resin), and the like. The entire disclosure of each of these United States patents is hereby incorporated by reference into this specification.

### Adhesion Properties and Adhesion Testing of Roofing Granules

The adhesion properties of roofing granules is extensively discussed in U.S. Pat. No. 5,380,552 (“Method of improving adhesion between roofing granules and asphalt-based material”), the entire disclosure of which is hereby incorporated by reference into this specification.

At lines 37-48 of U.S. Pat. No. 5,380,552, it is disclosed that “The exterior, outer, or exposed surface of asphalt roofing systems and products is generally provided with a covering of granular material or roofing granules embedded within the coating asphalt. The granular material generally protects the underlying asphalt coating from damage due to exposure to light, in particular ultraviolet (UV) light. That is, the granules reflect light and protect the asphalt from deterioration by photodegradation. In addition, such granular material improves fire resistance and weathering characteristics. Further, colors or mixtures of colors of granular material may be selected for aesthetics.”

Granule loss due to abrasion is discussed at the last paragraph of column 1 of U.S. Pat. No. 5,380,552, wherein it is disclosed that, “Granule loss can also occur due to physical abrasion of the granular surface. This may occur any time a person walks on an installed roof for maintenance, during installation of the roofing surface or by such environmental conditions as tree branches rubbing on the granular surface and the physical contact of rain or hail with the roofing surface.”

The benefits of reducing such granule loss are discussed at lines 34-37 of column 4 of U.S. Pat. No. 5,380,552, wherein it is disclosed that, “Improved granule retention increases the useful life of the roofing system by inhibiting exposure of the asphalt layer to ultraviolet light and thus inhibiting photodegradation of the coating asphalt.”

At lines 13-39 of column 5 of U.S. Pat. No. 5,380,552, the asphalt used in making roofing flux is disclosed. In this section of such patent, it is stated that: “Roofing asphalt, sometimes termed “asphalt flux”, is a petroleum based fluid comprising a mixture of bituminous materials. In the manufacture of roofing it is generally desirable to soak the absorbent felt or fiberglass mat until it is impregnated or saturated to the greatest possible extent with a ‘saturant’ asphalt, thus the asphalt should be appropriate for this purpose. Saturant asphalt is high in oily constituents which provide waterproofing and other preservatives. Substrates saturated with saturant asphalt are generally sealed on both sides by application of a hard or more viscous ‘coating asphalt’ which itself is protected by the covering of mineral granules. In the case of fiberglass mat based asphalt roofing products, it is well understood that the coating asphalt can be applied directly to the unsaturated fiberglass mat. The asphalts used for saturant asphalt and the coating asphalt are prepared by processing the asphalt flux in such a way as to modify the temperature at which it will soften. The softening point of saturant asphalt varies from about 37° C. to about 72° C., whereas the softening point of desirable coating asphalt runs as high as about 127° C. The softening temperature may be modified for application to roof systems in varying climates. In general, conventional, commercially available, asphalt systems may be utilized in applications of the present invention.”

A conventional means of making roofing shingles is discussed at columns 7-9 of U.S. Pat. No. 5,380,552. In the paragraph beginning at line 46 of column 7 of such patent, it is disclosed that, “A schematic generally illustrating preparation of roofing shingles according to the present invention is illustrated in FIG. 1. Except for addition of adhesives as described, and modifications to accommodate addition of adhesives as described, the system in FIG. 1 is generally as presented in U.S. Pat. No. 4,352,837 . . . , incorporated herein by reference. In operation, a roll of dry felt or bonded fiberglass mat 12, (the substrate) in sheet form, is installed on a feed roll 13 and unwound onto a dry looper 14. The dry looper 14 acts as a reservoir of mat material that can be drawn upon during the manufacturing operation to inhibit stoppages which might otherwise occur when new or additional rolls are fed into the system. Dry felt, or mat 12, is subjected to a hot asphalt saturating process, indicated generally at 15, after it passes through dry looper 14. The purpose of the asphalt saturating process 15 is to eliminate moisture and to fill the intervening spaces of the fibers of the substrate 12 as completely as possible. The saturating process is conducted in a saturation tank 16 in which saturating asphalt is contained. Sufficient heat is added to maintain the saturant asphalt in saturation tank 16 as a flowable liquid, typically at application temperatures of at least about 70° C.”

In the paragraph beginning at line 3 of column 8 of U.S. Pat. No. 5,380,552, it is disclosed that: “Following saturation tank 16, the saturated web 17 is passed through wet looper 18 whereat it is cooled and shrunk, permitting excess asphalt material to be further drawn into the substrate. The mat 12, after saturation with saturating asphalt in tank 16, is next passed through looper 18 and is then directed into coating area 20, for uniform coating with a coating asphalt, to the top and bottom of the mat. Coating area 20 contains a material reservoir 22 and an applicator with a distributor nozzle 23, which are operated to apply the asphalt coating material to the top surface of the mat. Excess coating material flows over the sides of the substrate and into a pan (not shown) from which it is picked up by adjustable rollers 25 for application to the bottom of the web, in a uniform layer. If, the mat 12 comprises a fiberglass mat, it is well accepted in the industry that the coating asphalt can be directly applied to an unsaturated fiberglass mat, although it may be saturated first. Thus, the above-described process can be modified by feeding the fiberglass mat 12 directly from dry looper 14 to the coating area 20. At station 30, an adhesive reservoir 31 and applicator with distributor nozzle 32 are shown. The hot-melt adhesive is contained within adhesive reservoir 31 and is distributed to the upper surface of asphalt-coated web 33 by distributor nozzle 32. The adhesive may be applied in a variety of patterns and manners. In general, satisfactory results are obtained if the adhesive is applied in thin streams on the order of about 100-200 micrometers in diameter, for example with a blown-fiber adhesive spray gun such as that manufactured by PAM Fastening Technology, Model PAM 500KS. The thin streams may be applied in a random pattern or in other patterns. In general, for some improvement all that is required is that an effective amount of adhesive be applied to the asphalt-coated web 33 upper surface to which granular material is eventually applied. By the term ‘effective amount’, in this context, it is meant that an amount of adhesive is applied such that with respect to loss of granular material due to moisture attack or deterioration, the resulting product is improved. In addition, in many applications such an amount of adhesive will also improve dry adhesion. Hereinbelow, a ‘wet rub test’ and a ‘dry rub test’ are described, by which improvement can be evaluated. The dry rub test is conducted in accordance with ASTM Standard Test D 4977, and this standard test is also used in the present invention to determine the grams of granules lost.

In the paragraph beginning at line 49 of column 8 of U.S. Pat. No. 5,380,552, it is disclosed that: “Preferably the adhesive is distributed in thin streams of about 100-200 micrometers diameter until at least about 25% and more preferably 50-75% of the upper surface of asphalt-coated web 33 is covered thereby. Preferably, the adhesive is applied while the coating asphalt is still hot, i.e. on the order of at least 170° C. (340° F.). Still referring to FIG. 1, roofing granules are contained within hopper or blender 24. They are applied to the upper surface of adhesive-coated web 43 by gravity feed through granule distributor 42. Excess granules may be picked up by a mechanism generally indicated at spill area 46. In addition, the underside 44 of web 43 may be coated with talc, mica or other suitable materials which are applied by a distributor 48. In order to obtain proper adhesion of the granules, the sheet granules are subject to controlled pressure by compression rollers or drums 51 which force the granules into the asphaltic coating material (and adhesive) a predetermined depth. Cooling may be added to these drums or rollers to cool the hot asphalt as the granules are pressed or embedded therein.”

In the paragraph beginning at line 3 of column 9 of U.S. Pat. No. 5,380,552, it is disclosed that: “The web with granules embedded therein, 52, then travels through tension roller area 53 which assists in feeding the web material through the previously-disclosed process. The web material 52, with the granules embedded therein, is then fed to a finished or cooling looper 50. The primary function of this looper is to cool the sheet down to a point where it can be cut and packed without danger to the material. Subsequent to the cooling looper 50, the sheet may be fed to a roll roofing winder 54. Here the sheet is wound on a mandrel which measures the length of the material as it turns. When sufficient material has accumulated it is cut off, removed from the mandrel and passed on for wrapping. Alternatively, the sheet leaving the cooling looper 50 may be fed to a shingle cutter 56. It will be understood that the finished sheet or web may be cut to desired shapes or sizes and it may be modified, for example, by the addition of liners, application adhesives, or other modifications. The cut shapes or sizes are transferred to a stacking/packing area 58. The type of processing described above is well-known in the manufacturing of shingles or other roof materials, for example, as described in U.S. Pat. No. 4,352,837, which is incorporated herein by reference.”

A “Dry Rub Test” for determining the extent of adherence of the roofing granules is described at lines 12-46 of column 10 of U.S. Pat. No. 5,380,552. ASTM standard test D 4977-89 was used for the “Dry Rub Test” used in U.S. Pat. No. 5,380,837. Comparable ASTM test D 4977-03 is also used for the “Dry Rub Test” described in this specification.

As is disclosed at lines 12-46 of column 10 of U.S. Pat. No. 5,380,552, “The dry rub test is a standard test method for the determination of granular adhesion to mineral-surfaced roofing under conditions of abrasion. The procedure is described in ASTM standard D 4977-89, incorporated herein by reference. Dry rub tests conducted to evaluate granular adhesion in products according to the present invention, were conducted in compliance with this standard. In general, a brush with 22 holes, each containing bristles made of 0.012 inch diameter tempered steel wire (40 wires per hole, set with epoxy) was used to abrade the granular surface of a specimen of mineral-surfaced roofing. The adhesion is assessed by weighing the amounts of granules that are displaced and become loose as a result of the abrasion test. The testing apparatus is a machine designed to cycle a test brush back and forth (horizontally) across a specimen at a rate of 50 cycles in a period of about 60-70 seconds while the brush assembly rests on the specimen with a downward mass of 5 pounds±¼ ounce with a stroke link of 6±¼ inch. The testing machine used is available commercially, as the 3M Granule Embedding Test Machine and Abrasion Test Brushes, Minnesota Mining & Manufacturing, Inc., St. Paul, Minn. A minimum of two 2-inch by 9-inch specimens were utilized for each test, and any loose granules were removed from the specimen with gentle tapping. Each specimen was then weighed and the mass was recorded. The specimen was then clamped to the test machine and the brush was placed in contact with the specimen (with activation of the machine so that the specimen was abraded 50 complete cycles, the brush traveling parallel to the long axis of the specimen). The specimen was then removed and weighed; the loss in mass then being calculated.”

### A Preferred Filler for Making Filled Asphalt Compositions

In one embodiment, the filler used to make the filled asphalt composition is the same or substantially the same as that filler that is disclosed in U.S. Pat. No. 7,833,339, the entire disclosure of which is hereby incorporated by reference into this specification.

Claim 1 of U.S. Pat. No. 7,833,339 describes: “1. A composition comprised of asphalt and filler, wherein said filler is comprised of particles that comprise an inorganic core and a coating disposed on said core, wherein at least about 60 weight percent of said particles are smaller than about 212 microns, and wherein: (a) at least 95 weight percent of said filler is comprised of particles of calcium carbonate; (b) said composition, at a temperature of from about 425 to about 475 degrees Fahrenheit, has a viscosity of from about 2000 to about 4500 centipoise; (c) said asphalt has a flash point of less than 540 degrees Fahrenheit; (d) said coating is comprised of an amine anti-strip agent; (e) said particles of calcium carbonate are comprised of particles of calcium carbonate that are smaller than 100 microns; (f) said particles of calcium carbonate are comprised of particles of calcium carbonate that are larger than 150 microns; (g) at least 80 weight percent of said particles of calcium carbonate that are smaller than 100 microns are coated with said coating comprised of said amine anti-strip agent; and (h) less than 10 weight percent of said particles of calcium carbonate that are larger than 150 microns are coated with said coating comprised of said amine anti-strip agent.”

Claim 2 of U.S. Pat. No. 7,833,339 describes: “2. The composition as recited in claim 1, wherein said composition is comprised of from about 71 to about 75 weight percent of said particles of calcium carbonate.” Claim 3 of this patent describes: “3. The composition as recited in claim 1, wherein said amine anti-strip agent is comprised of a polyamine.” Claim 4 of this patent describes: “4. The composition as recited in claim 3, wherein said polyamine is an epoxylated polyamine.”

In another section of this specification, there is disclosed the coating of headlap particles with an organic coating (such as mineral oil) that, optionally, may include an amine material. The very same organic coating may be used to coat the aforementioned filler particles of U.S. Pat. No. 7,833,339, and such coating may be used with or without the amine agent.

In another embodiment, the filler composition may contain less calcium carbonate than the 95 percent referred to in claim 1 of U.S. Pat. No. 7,833,339. In this embodiment, it may contain as little as 40% of calcium carbonate (thus allowing, e.g., the use of dolomitic limestone and other limestones that do not contain 95 weight percent of calcium carbonate), and it may contain either the lubricating oil, or the amine material, or a combination thereof.

In another embodiment, the amine material used is a polyamine such as, e.g., an epoxylated polyamine.

In one embodiment, the filler particles that are treated with the amine and/or the lubricating oil absorb, at least in part, the treatment material(s) so that the thickness of any coating that might exist on the particles is less than about 2 microns.

Use of the Filler Material Disclosed in U.S. Ser. No. 12/927,442

In one embodiment, the filler material used to make the filled asphalt is the same as or substantially the same as the filler material disclosed in applicants' copending patent application Ser. No. 12/927,442, the entire disclosure of which is hereby incorporated by reference into this specification.

The specification of U.S. Ser. No. 12/927,442 makes reference to published United States patent application 2007/0261337, stating that: “Applicants' published United States patent application US 2007/0261337, the entire disclosure of which is hereby incorporated by reference into this specification, describes and claims several different filler materials that may be chosen for use in step 12 of the process.” The entire disclosure of such published United States patent application US2007/0261337 is hereby incorporated by reference into this specification.

Claim 1 of published United States patent application US2007/0261337 describes: “1. A composition comprised of asphalt and filler, wherein said filler is comprised of particles that comprise an inorganic core and a coating disposed on said core, and wherein at least about 60 weight percent of said particles are smaller than about 212 microns.” The coating for such filler may be the hydrocarbon oil described in this specification, and/or the adhesion improving agent described in this specification.

Claim 12 of published United States patent application US2007/0261337 describes: “12. The composition as recited in claim 11, wherein said composition is comprised of from about 71 to about 75 weight percent of said mineral filler composition.” In accordance with this claim, the filled asphalt material used in applicants' shingle assemblies may contain, e.g., from about 71 to about 75 weight percent of the filler. In another embodiment, the filled asphalt material contains less than about 70 weight percent of the filler.

In one embodiment, applicants' shingle assemblies have the properties described in claims 16 et seq. of published United States patent application US2007/0261337, the entire disclosure of which is hereby incorporated by reference into this specification.

Thus, e.g., applicants' shingle assembly has the tear resistance discussed in claim 16 of such published patent application. Such claim 16 describes: “16. A composition comprised of from about 71 to about 75 weight percent of mineral filler material with a particle size less than 212 microns and from about 25 to about 29 weight percent of asphalt (by combined weight of said asphalt and said mineral filler with a particle size smaller than 212 microns) wherein, when said composition is incorporated into a glass felt mat with a density of from about 1.8 to about 1.9 pounds per 100 square feet and made into a single-layer roofing shingle, said shingle, after having been subjected to at least 10 cycles of Cycle A of ASTM standard test D 4798-04, has a tear resistance of at least 1,700 grams.”

Claim 20 of such published patent application states: “20. The composition as recited in claim 13, wherein said limestone is comprised of at least 60 percent of particles less than 212 microns in size but greater than 74 microns in size.” In one embodiment, at least 60 weight percent of the filler is limestone with a particle size in the range from 74 microns to 212 microns. In one aspect of this embodiment, less than about 2 weight percent of the particles of said limestone are greater than 250 microns.”

Thus, e.g., applicants' shingle assembly has the fastener pull through resistance discussed in claim 33 of such published patent application. Such claim 33 describes: “33. A mineral filler material with a particle size less of than about 212 microns wherein, when said mineral filler material is mixed with asphalt to produce a roofing composition that is comprised of from about 25 to about 29 weight percent of asphalt and from about 75 to about 71 weight percent of said mineral filler composition, (by combined weight of said asphalt and said mineral filler material), and wherein when said composition is incorporated into a glass felt mat with a density of from about 1.8 to about 1.9 pounds per 100 square feet and made into a multi-layer roofing shingle, said shingle, when tested for at least 10 cycles of Cycle A of ASTM standard test D 4798-04, will have a fastener pull-through resistance at a temperature of 23 degrees Celsius of at least about 135 Newton's.”

Thus, e.g., applicants' shingle assembly has the fastener pull through resistance discussed in claim 34 of such published patent application. Such claim 34 describes: “34. A mineral filler material with a particle size less of than about 212 microns wherein, when said mineral filler material is mixed with asphalt to produce a roofing composition that is comprised of from about 25 to about 29 weight percent of asphalt and from about 75 to about 71 weight percent of said mineral filler material (by combined weight of said asphalt and said mineral filler material), and wherein when said composition is incorporated into a glass felt mat with a density of from about 1.8 to about 1.9 pounds per 100 square feet and made into a single-layer roofing shingle, said shingle, when tested for at least 10 cycles of Cycle A of ASTM standard test D 4798-04, will have a fastener pull-through resistance at a temperature of 0 degrees Celsius of at least about 104 Newton's.”

Thus, e.g., applicants' shingle assembly has the fastener pull through resistance discussed in claim 35 of such published patent application. Such claim 35 describes: “35. A mineral filler material with a particle size less of than about 212 microns wherein, when said mineral filler material is mixed with asphalt to produce a roofing composition that is comprised of from about 25 to about 29 weight percent of asphalt and from about 75 to about 71 weight percent of said mineral filler material (by combined weight of said asphalt and said mineral filler material), and wherein when said composition is incorporated into a glass felt mat with a density of from about 1.8 to about 1.9 pounds per 100 square feet and made into a multi-layer roofing shingle, said shingle, when tested for at least 10 cycles of Cycle A of ASTM standard test D 4798-04, will have a fastener pull-through resistance at a temperature of 0 degrees Celsius of at least about 180 Newton's.”

In one preferred embodiment, the limestone that is coated to produce the filler material is “A85/200” limestone produced by Franklin Industrial Minerals of 9020 Overlook Blvd., Suite 200, Brentwood, Tennesee 37027. This product contains material with a particle size distribution such that at least 99 percent of the particles pass a 60 mesh screen, and at least 78 percent of the particles pass a 200 mesh sieve. This material contains at least 96 percent of calcium carbonate.

In one preferred embodiment, the hydrocarbon oil referred to elsewhere in this specification may be used to coat the limestone particles. One hydrocarbon oil that may advantageously be used is, e.g., naphthenic mineral oil.

The naphthenic mineral oil, e.g., may advantageously be used to provide a coated mineral filler that is then mixed with asphalt.

Naphthenic mineral oils, and other “process oils,” are discussed in another portion of this specification.

In one embodiment, the additive used to coat the limestone is naphthenic mineral oil, the coated limestone is present at a loading of at least 71 weight percent in the filler/asphalt mixture, and the viscosity of such mixture at a temperature of from 425 to about 475 degrees Fahrenheit is from about 2,000 to about 4500 centipoise. In one aspect of this embodiment, the particle size distribution of the coated limestone material is such that it contains less than about 5 weight percent of the fines that are smaller than about 10 microns.

Similar results are obtained under substantially the same conditions when the naphthenic mineral oil is replaced, in whole or in part, petroleum based oils and/or animal oil (lard, e.g.) and/or naturally occurring oils (such as plant oils). Thus, by way of illustration, one may use soy oil, corn oil, sunflower oil, palm oil, and the like.

In one embodiment, the naphthenic mineral oil is replaced by a lubricant that lubricates the surfaces of the limestone particles.

In one embodiment, the naphthenic mineral oil is replaced, in whole or in part, by an additive that creates a water-impervious coating on the particles of limestone. In general, such coating is from about 10 to about 200 microns thick; and it preferably increases the lubricity of the surfaces of the coated particle.

In one embodiment, from about 0.1 to about 5.0 percent of the naphthenic mineral oil is coated onto the limestone particles. In one aspect of this embodiment, from about 0.2 to about 1.0 weight percent of such additive is used.

In one embodiment, only those limestone particles that are smaller than 74 microns are coated with the additives. In another embodiment, only those limestone particles that are larger than 74 microns are coated with the additives. In another embodiment, particles smaller than 74 microns are treated with one additive, and particles larger than 74 microns are treated with another additive. In yet another embodiment, all of the particles in the limestone are coated with the same additive.

In another embodiment, the additive used to coat the limestone is either a dispersing agent and/or an electrolyte as those terms are defined in U.S. Pat. No. 4,282,006, the entire disclosure of which is hereby incorporated by reference into this specification.

Thus, e.g., the dispersing agent may be present at a weight of from about 0.05 to about 2 weight percent. Thus, e.g., the dispersing agent may be an organic or inorganic surfactant and characterized in that said surfactant is an anionic surfactant. Thus, e.g., the dispersing agent may be an anionic surfactant selected from the group consisting of (i) 2-ethylhexyl polyphosphoric ester acid anhydride and its potassium salt, (ii) complex organic polyphosphoric ester acid anhydride and its potassium salt, (iii) alkyl mononaphthalene sulfonic acid and its sodium and ammonium salts, and (iv) mixtures thereof.

In one embodiment, the viscosity reducing additive that is used in such step 24 is a polyamine such as, e.g., epoxylated polyamine.

Some preferred polyamines are disclosed in U.S. Pat. No. 4,430,127, the entire disclosure of which is hereby incorporated by reference into this specification.

In one embodiment, one may use one or more of the asphalt additives sold by the “ArrMaz Custom Chemicals” company of 4800 State Road 60 East, Mulberry, Fla. 33860 to coat the limestone. These additives include, e.g., “AD-here HP Plus,” “ACRA 500,” “AD-here LOF 65-00,” AD-here 64-10,” tallow diamine, amido amines and salts, aminoester from tall oil fatty acid and triethanolamine, and the like.

In one embodiment, one may use silicone oils sold by Goldschmidt Chemical of Hopewell, Va. under the names of “Tegosivin HL100,” “Tegosivin HL 15M7,” and “Tegopren 6800” and “Tegopren 5840” to coat the limestone.

In one embodiment, one may coat the limestone with fatty acid amines such as lauryl amine and stearyl amine; amido amine anti-strip agents and/or salts thereof; unsaturated carboxylic acid anti-strip agents; alpha-olefin copolymers; polyetheramine fatty acid salts; fatty acids such as, e.g., oleic acid and stearic acid; naphthenic oils such as that sold by the Cross Oil company as “HS-500;” alkylene diamines; dialkyl amines; the aminoester products produced by the reaction of tall oil fatty acid and triethanolamine that are described in U.S. Pat. No. 4,806,166, the entire disclosure of which is hereby incorporated by reference into this specification; polyamine anti-strip agents such as, “PAVEBOND LITE” by the Morton International company, an anti-strip agent sold by the Arizona Chemical company as “100NS.”

### A Preferred Asphalt Shingle

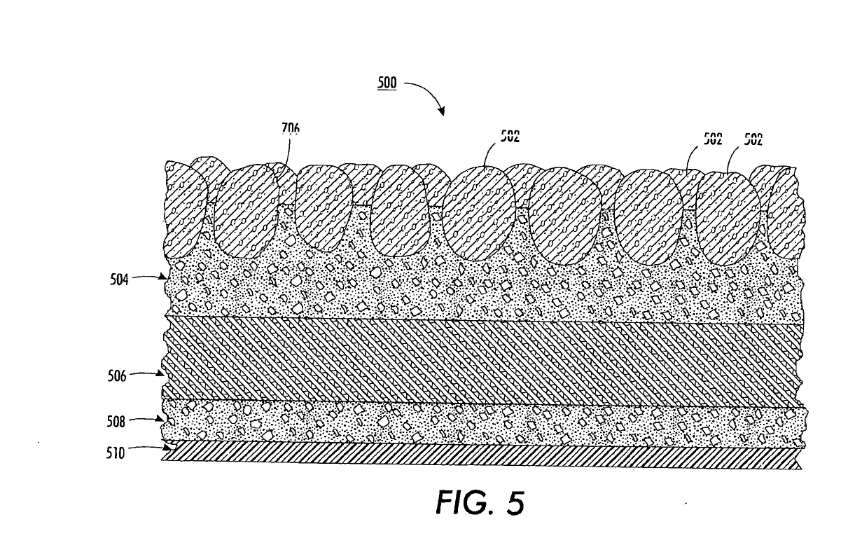

FIG. 5 is a schematic diagram of an asphalt shingle 500 made in accordance with the procedure described elsewhere in this specification. The headlap particles 502 made in accordance with the process of this invention are disposed within an asphalt material 504 that, in one embodiment is a stabilized asphalt.

Referring to FIG. 5, it will be seen that the headlap particles 502 are preferably not spherical, i.e., their aspect ratios (the ratio of the largest axis of the particle to the smallest axis) is greater than 1.0. In general, the aspect ratio of the headlap particles is from about 1.4 to about 2.0.

Referring again to FIG. 5, it will be seen that, in the embodiment depicted, the headlap particles are not homogeneous, i.e., different of the particles 502 have different sizes and/or shapes. Furthermore, different of the particles 502 are disposed within the asphalt 504 to different depths.

In the embodiment depicted in FIG. 5, the asphalt 504 is disposed over a fiberglass base 506 that is contiguous with both the top layer of asphalt 504 and the bottom layer of asphalt 508. A bottom backsurfacing layer 510 is contiguous with the bottom layer of asphalt 508.

### EXAMPLES

The following examples are presented to illustrate one preferred embodiment of the invention but are not to be deemed limitative thereof. Unless otherwise specified, all parts are by weight and all temperatures are in degrees Celsius.

In each of the following examples, roofing granules were used to make a sample shingle, and the sample shingle was then tested for granule adhesion in accordance with ASTM Standard Test 4977-3. The procedure for making the test samples is described hereinbelow.

In the experiments described in the examples, a pigmented limestone headlap material that was comprised of naphthenic mineral oil and/or an amine antistrip agent was prepared in accordance with the detailed description set forth in the preceding section of this specification. Test samples were then prepared utilizing this headlap material in accordance with the procedure described elsewhere in this specification with regard to A.S.T.M. D-4977-3. A roofing granule sample is deemed to pass the ASTM D 4977-3 test only if the sample being tested loses less than 5.0 grams of material.

A finely divided limestone filler, “grade 85-200 mesh shingle filler,” was obtained from the Franklin Industrial Minerals Company Nashville, Tenn. This filler was blended with the “asphalt shingle coating” to a final level of 65 weight percent filler. This blended material is referred to hereinafter as “filled asphalt coating,” and it had a final Ring & Ball Softening Point of 251 degrees Fahrenheit (as determined by ASTM D 36) as well as a Needle Penetration of 6 decimillimeters at 77 degrees Fahrenheit (as determined by ASTM D 5).

The viscosity of the “filled asphalt coating,” as determined by ASTM D 4402, was 6517 centipoise at 400 degrees Fahrenheit, 1867 centipoise at 450 degrees Fahrenheit, and 1133 centipoise at 475 degrees Fahrenheit.

The “filled asphalt coating” was then applied to a commercially available bonded non-woven glass roofing fabric with a dry weight of approximately 1.68 pounds per one hundred square feet. This fabric consisted of sized individual “E” Glass filaments of 15.25-16.5 microns in diameter (“M” fiber) and from 0.75-1.25 inches in length, which are randomly oriented and bonded with a modified urea-formaldehyde resin binder, which has been applied to a level of 20.8% (dry weight). This fabric was obtained from the Johns Manville Corporation of Denver, Colo.

The aforementioned glass fabric was coated on each side and saturated throughout with the aforementioned “filled asphalt coating” at a temperature of 425 degrees Fahrenheit by using a squeegee to force the coating into the glass fabric. After the glass fabric had been fully saturated with the “filled asphalt coating,” 60 mils of such “filled asphalt coating” were applied to the top side of each sample sheet to form a coating. Thereafter, granule particles were sprinkled onto the coating as described hereinbelow.

Samples of treated, untreated and control granule particles produced for these experiments were immediately sprinkled on the top surface of the warm sheet(s); the granules were applied within no more than 5 minutes after the coating was applied. The granule particles were then roll pressed into the coated glass sheet using a 10 pound roller. The rolled-pressed samples were then allowed to cool to ambient temperature and thereafter were used for the adhesion experiments described hereinbelow.

After the finished sheets were cooled to ambient temperature, they were then cut into 2 inch by 9 inch sample specimens for further “rub-loss testing” in accordance with ASTM D 4977-03. Prior to such “rub-loss testing,” loose granule particles were removed from the samples by gentle tapping of the specimens.

At least two sample specimens were cut for each trial variant, with the long dimension of the specimen in the machine direction or press-roll direction. Specimens were conditioned at room temperature of 73.4 degrees Fahrenheit plus or minus 3.6 degrees Fahrenheit) for at least 30 minutes before testing. Granule abrasion tests were conducted using a Granule Test Apparatus as described in ASTM Procedure D 4977-03. All loose granules were removed from the specimens by gentle tapping of the sample. Each specimen was weighed to the nearest 0.01 grams and a record was made of the initial weight of the specimen. The specimen was centered in the sample holder of the Test Apparatus with the mineral surface facing up and the long axis of the specimen aligned with the brush stroke of the Test Apparatus. The Test Apparatus was activated such that the specimen was abraded 50 complete cycles, each cycle consisting of a forward stroke and a back stroke, with the brush travel remaining parallel to the long axis of the specimen. The specimen was removed from the sample holder and any loose granules were removed from the sheet by gently tapping the sample. The specimen was weighed to the nearest 0.01 grams and a record was made of the final weight of the specimen. The difference in weights for multiple samples of the same specimen were calculated and averaged to determine the average granule loss by abrasion.

### Examples 1-10

### Experimental Results

In the experiments described in Examples 1-11, ten different variants of treated limestone granule shingle specimens were tested upon completion of the fabrication of the test samples and after one week of moist storage to determine the relative granule rub-loss amounts under ASTM D-4977-03. For each set of conditions, rub loss results are reported for both un-aged samples, and aged samples (the aged samples being those that had been subjected to a water quench and stored in an un-dried state for one week.).

The limestone roofing granules used in these experiments of Examples 1-11 were obtained from the Franklin Industrial Mineral Corporation of Nashville Tenn. as “limestone headlap granules.” They had a particle size distribution such that at least about 80 weight percent of said granules had sizes in the range of from about 600 to about 1400 microns, and less than about 4 weight percent of said headlap granules were smaller than 250 microns. These limestone granules were produced at the Anderson, Tenn. plant of the Franklin Industrial Mineral Corporation.

In the experiment of Example 1, the roofing granules were coated with 0.5 gallons per ton of a 50/50 mixture of an amido amines sold as “AD-HERE” LOF 6500” (sold by Arr Maz Custom Chemicals, Inc. of Winterhaven, Fla.) and “HYPRENE 100” naphthenic oil sold by Ergon Refining, Inc. of Jackson, Miss. This oil had a viscosity of from 100 to 115 Saybolt Universal Seconds (SUS), as measured by ASTM D445, an American Petroleum Institute (API) gravity at 60 degrees Fahrenheit of 24.6 (as measured by ASTM D1260), and a Cleveland Open Cup (COC) flash point of between 325 and 340 degrees Fahrenheit (as measured by ASTM D92). The un-aged sample produced with these headlap granules had a rub loss of 4.8 grams and the aged sample had a rub loss of 4.4 grams.

In the experiment of Example 2, the same mixture was used as specified in Example 1, but the application rate was 1.0 gallon per ton rather than 0.5 gallons per ton. The un-aged sample produced with these roofing granules granules had a rub loss of 4.5 grams, and the aged sample had a rub loss of 4.2 grams.

In the experiment of Example 3, the same mixture was used as specified in Example 1, but the application rate was 1.5 gallons per ton rather than 0.5 gallons per ton. The un-aged sample produced with these roofing granules granules had a rub loss of 3.8 grams, and the aged sample had a rub loss of 4.3 grams.

In the experiment of Example 4, the “AD-HERE” LOF 6500″ was replaced with “AD-HERE” LOF 6500LS″ amido-amine that was also obtained from Arr Maz Custom Chemicals, Inc. of Winterhaven, Fla. and was also applied as a 50/50 mixture at an application rate of 0.5 gallons per ton. The un-aged sample produced with these roofing granules granules had a rub loss of 4.7 grams, and the aged sample had a rub loss of 4.3 grams.

In the experiment of Example 5, the same mixture used in Example 4 was used, but the application rate was 1.0 gallon per ton. The un-aged sample produced with these roofing granules had a rub loss of 4.5 grams, and the aged sample had a rub loss of 4.7 grams.

In the experiment of Example 6, the same mixture used in Example 4 was used, but the application rate was 1.5 gallons per ton. The un-aged sample produced with these roofing granules had a rub loss of 4.9 grams, and the aged sample had a rub loss of 5.1 grams.

In the experiment of Example 7, the same amido-amine was used, but none of the oil was used. The application rate was 1 gallon per ton of such amine. The un-aged sample produced with these roofing granules had a rub loss of 4.4 grams and the aged sample had a rub loss of 4.9 grams.

In the experiment of Example 8, the same oil was used, but none of the amido-amine was used. The application rate was 1 gallon per ton of such oil. The un-aged sample produced with these roofing granules had a rub loss of 4.2 grams and the aged sample had a rub loss of 4.4 grams.

In the experiment of Example 9, the mixture described in Example 1 was used at an application rate of 1.75 gallons per ton. The un-aged sample produced with these roofing granules had a rub loss of 3.7 grams.

In the experiment of Example 10, the mixture of Example 1 was used at an application rate of 2.0 gallons per ton. The un-aged sample produced with these roofing granules had a rub loss of 4.6 grams.

### Experimental Observations and Other Observations

The data regarding the experiments discussed in Examples 1-11 demonstrate that either the lubricating oil additive(s), or the amine additive, or a combination thereof, will improve the adhesion properties of headlap granules made in a certain manner, to wit, granules to which the additive has been applied by spraying the granules with an aerosol mist of the additive(s).

The discussion in the preceding sections of this specification has focused on the use of certain granular materials in the preparation of asphalt shingles. In another embodiment, these granular materials may also be used to prepare modified bitumen roofing products.

We claim:

1. A shingle assembly comprised of a fiber mat with a top surface and a bottom surface and an asphalt mixture disposed within said fiber mat, wherein said asphalt mixture is comprised of asphalt and a mineral filler, wherein a layer of roofing granules is disposed on said top surface of said fiber mat, wherein said roofing granules are comprised of at least 80 weight percent of limestone particles that have a hardgrove grindability index of less than 70, wherein said roofing granules are coated with a hydrocarbon oil, and wherein said coated roofing granules, when tested in accordance with A.S.T.M. standard test D4977-3, lose less than 5.0 grams of material.

2. The shingle assembly as recited in claim 1, wherein said roofing granules are comprised of at least 40 weight percent of calcium carbonate.

3. The shingle assembly as recited in claim 1, wherein said roofing granules are comprised of at least 60 weight percent of calcium carbonate.

4. The shingle assembly as recited in claim 1, wherein said roofing granules are comprised of at least 80 weight percent of calcium carbonate.

5. The shingle assembly as recited in claim 4, wherein said roofing granules are comprised of from about 0.1 to about 1.0 weight percent of a pigmented material.

6. The shingle assembly as recited in claim 5, wherein said pigmented material is comprised from about 10 to about 35 weight percent of pigment and from about 90 to about 65 weight percent of a resin.

7. The shingle assembly as recited in claim 6, wherein said roofing granules are comprised of an amine.

8. The shingle assembly as recited in claim 7, wherein said resin is a synthetic resin.

9. The shingle assembly as recited in claim 8, wherein said pigmented material is comprised of from about 10 to about 20 weight percent of said pigment.

10. The shingle assembly as recited in claim 9, wherein said pigment is carbon black.

11. The shingle assembly as recited in claim 8, wherein said synthetic resin is an ester of pentaerythritol and rosin.

12. The shingle assembly as recited in claim 1, wherein said limestone particles have a hardgrove grindability index of less than about 68.

13. The shingle assembly as recited in claim 1, wherein said limestone particles have a hardgrove grindability index of less than about 60.

14. The shingle assembly as recited in claim 1, wherein said limestone particles have a hardgrove grindability index of from about 55 to about 58.

15. The shingle assembly as recited in claim 1, wherein said limestone particles have a particle size distribution that ranges from about 500 microns to about 2000 microns.

16. The shingle assembly as recited in claim 1, wherein at least about 90 weight percent of said limestone particles have a maximum dimension within the range of from about 420 microns to about 2000 microns.

17. The shingle assembly as recited in claim 1, wherein said limestone particles have a particle size distribution such that from about 2 to about 10 weight percent of said particles are retained on a 1680 micron screen.

18. The shingle assembly as recited in claim 17, wherein said limestone particles have a particle size distribution such that from about 23 to about 50 weight percent of said particles are retained on a 1190 micron screen.

19. The shingle assembly as recited in claim 18, wherein said limestone particles have a particle size distribution such that from about 48 to about 77 weight percent of said particles are retained on a 840 micron screen.

20. The shingle assembly as recited in claim 19, wherein said limestone particles have a particle size distribution such that from about 80 to about 95 weight percent of said particles are retained on a 590 micron screen.

21. The shingle assembly as recited in claim 1, wherein said limestone particles have a particle size distribution such that their distribution modulus is from about 0.08 to about 0.14.

22. The shingle assembly as recited in claim 1, wherein said hydrocarbon oil forms a coating on said roofing granules with a thickness of from about 200 to about 2000 nanometers.

23. The shingle assembly as recited in claim 1, wherein said hydrocarbon oil forms a coating on said roofing granules with a thickness of from about 300 to about 1200 nanometers.

24. The shingle assembly as recited in claim 1, wherein said hydrocarbon oil is a naphthenic mineral oil.

25. The shingle assembly as recited in claim 1, wherein said coated roofing granules have a Mohs hardness of from about 2.5 to about 3.5.

26. The shingle assembly as recited in claim 1, wherein said coated roofing granules have a Mohs hardness of from about 2.9 to about 3.1.

27. The shingle assembly as recited in claim 1, wherein said fiber mat is a glass fiber mat.

28. A process for preparing a shingle assembly comprising the steps of providing limestone granules with a hardgrove grindability of less than 70, and spraying a hydrocarbon oil onto said limestone granules to form coated limestone granules.

29. The process as recited in claim 28, wherein said hydrocarbon oil when it is sprayed onto said limestone granules has a viscosity of from about 70 to about 300 centipoise.

30. The process as recited in claim 28, wherein said hydrocarbon oil when it is sprayed onto said limestone granules has a viscosity of from about 80 to about 120 centipoise.

31. The process as recited in claim 29, wherein a layer of said coated limestone granules are disposed onto the top surface of a fiber mat, and wherein said fiber mat is comprised of asphalt disposed within said fiber mat.

32. The process as recited in claim 31, wherein said hydrocarbon oil forms a coating on said limestone granules with a thickness of from about 200 to about 2000 nanometers.

33. The process as recited in claim 31, wherein said hydrocarbon oil forms a coating on said roofing granules with a thickness of from about 300 to about 1200 nanometers.

34. The process as recited in claim 31, wherein said hydrocarbon oil is a naphthenic mineral oil.

35. The process as recited in claim 31, comprising the step of forming said hydrocarbon oil into an aerosol of fine droplets and contacting said aerosol of fine droplets with said limestone granules.

36. The process as recited in claim 35, comprising the step of heating said hydrocarbon oil to a temperature above ambient temperature prior to forming said hydrocarbon oil into an aerosol of fine droplets.

37. The process as recited in claim 36, wherein said coated limestone granules have a Mohs hardness of from about 2.5 to about 3.5.

38. The process as recited in claim 36, wherein said coated limestone granules have a Mohs hardness of from about 2.9 to about 3.1.

39. The process as recited in claim 36, comprising the step of adhering said coated limestone granules to said top surface of said fiber mat.

40. The process as recited in claim 39, wherein said fiber mat is a glass fiber mat.

41. The process as recited in claim 28, wherein said limestone granules are comprised of at least 40 weight percent of calcium carbonate.

42. The process as recited in claim 28, wherein said limestone granules are comprised of at least 60 weight percent of calcium carbonate.

43. The process as recited in claim 28, wherein said limestone granules are comprised of at least 80 weight percent of calcium carbonate.

44. The process as recited in claim 28, wherein said limestone granules have a hardgrove grindability index of less than about 68.

45. The process as recited in 28, wherein said limestone granules have a hardgrove grindability index of less than about 60.

46. The process as recited in claim 28, wherein said limestone granules have a hardgrove grindability index of from about 55 to about 58.

47. The process as recited in claim 28, wherein said limestone granules have a particle size distribution that ranges from about 500 microns to about 2000 microns.

48. The process as recited in claim 28, wherein at least about 90 weight percent of said limestone granules have a maximum dimension within the range of from about 420 microns to about 2000 microns.

49. The process as recited in claim 28, wherein said limestone granules have a particle size distribution such that from about 2 to about 10 weight percent of said particles are retained on a 1680 micron screen.

50. The process as recited in claim 49, wherein said limestone granules have a particle size distribution such that from about 23 to about 50 weight percent of said particles are retained on a 1190 micron screen.

51. The process as recited in claim 50, wherein said limestone granules have a particle size distribution such that from about 48 to about 77 weight percent of said particles are retained on a 840 micron screen.

52. The process as recited in claim 51, wherein said limestone granules have a particle size distribution such that from about 80 to about 95 weight percent of said particles are retained on a 590 micron screen.

53. The process as recited in claim 28, wherein limestone granules have a particle size distribution such that their distribution modulus is from about 0.08 to about 0.14.

54. The process as recited in claim 28, wherein hydrocarbon oil forms a coating on said limestone granules with a thickness of from about 200 to about 2000 nanometers.

55. The process as recited in claim 28, wherein said hydrocarbon oil forms a coating on said limestone granules with a thickness of from about 300 to about 1200 nanometers.

56. The process as recited in claim 28, wherein said hydrocarbon oil is a naphthenic mineral oil.

57. The process as recited in claim 31, wherein said fiber mat is a glass fiber mat.

58. The shingle assembly as recited in claim 1, wherein said mineral filler is comprised of particles that comprise an inorganic core and a coating disposed on said core, and wherein at least about 60 weight percent of said particles are smaller than about 212 microns.”

59. The shingle assembly as recited in claim 58, wherein said asphalt mixture is comprised of from about 71 to about 75 weight percent of said mineral filler.

60. The shingle assembly as recited in claim 58, wherein said asphalt mixture contains less than about 70 weight percent of said mineral filler.

61. The shingle assembly as recited in claim 59, wherein, when said asphalt mixture is incorporated into a glass felt mat with a density of from about 1.8 to about 1.9 pounds per 100 square feet and made into a single-layer roofing shingle, said shingle, after having been subjected to at least 10 cycles of Cycle A of ASTM standard test D 4798-04, has a tear resistance of at least 1,700 grams.

62. The shingle assembly as recited in claim 58, wherein at least about 60 weight percent of said mineral filler is comprised of limestone.

63. The shingle assembly as recited in claim 63, wherein at least 60 percent of the particles of said mineral filler are greater than 74 microns in size.

64. The shingle assembly as recited in claim 63, wherein less than about 2 weight percent of the particles of said mineral filler are greater than 250 microns.

65. The shingle assembly as recited in claim 59, wherein when said asphalt composition is incorporated into a glass felt mat with a density of from about 1.8 to about 1.9 pounds per 100 square feet and made into a multi-layer roofing shingle, said shingle, when tested for at least 10 cycles of Cycle A of ASTM standard test D 4798-04, will have a fastener pull-through resistance at a temperature of 23 degrees Celsius of at least about 135 Newtons.

66. The shingle assembly as recited in claim 59, wherein when said asphalt composition is incorporated into a glass felt mat with a, density of from about 1.8 to about 1.9 pounds per 100 square feet and made into a single-layer roofing shingle, said shingle, when tested for at least 10 cycles of Cycle A of ASTM standard test D 4798-04, will have a fastener pull-through resistance at a temperature of 0 degrees Celsius of at least about 104 Newtons.

67. The shingle assembly as recited in claim 59, wherein when said asphalt composition is incorporated into a glass felt mat with a density of from about 1.8 to about 1.9 pounds per 100 square feet and made into a multi-layer roofing shingle, said shingle, when tested for at least 10 cycles of Cycle A of ASTM standard test D 4798-04, will have a fastener pull-through resistance at a temperature of 0 degrees Celsius of at least about 180 Newtons.

68. The shingle assembly as recited in claim 58, wherein said coating is a hydrocarbon oil.

69. The shingle assembly as recited in claim 58, wherein said coating is naphthenic mineral oil.

70. The shingle assembly as recited in claim 58, wherein said coating is a process oil.

71. The shingle assembly as recited in claim 58, wherein said coating is a hydrocarbon oil.

72. The shingle assembly as recited in claim 58, wherein said coating is a petroleum based oil.

73. The shingle assembly as recited in claim 58, wherein said coating is an animal oil.

74. The shingle assembly as recited in claim 58, wherein said coating is a plant oil.

75. The shingle assembly as recited in claim 58, wherein said coating is a lubricant.

76. The shingle assembly as recited in claim 58, wherein said coating is a water impervious coating.

77. The shingle assembly as recited in claim 58, wherein said coating is a dispersing agent.

78. The shingle assembly as recited in claim 58, wherein said coating is an electrolyte.

79. The shingle assembly as recited in claim 58, wherein said coating is a polyamine.

80. The shingle assembly as recited in claim 58, wherein said coating is an epoxylated polyamine.

81. The shingle assembly as recited in claim 58, wherein said coating is a selected from the group consisting of tallow diamine, amido amines, salts of amido amines, triethanolamine, and mixtures thereof.

82. The shingle assembly as recited in claim 58, wherein said coating is a silicone oil.

83. The shingle assembly as recited in claim 58, wherein said coating is a fatty acid amine.

84. The shingle assembly as recited in claim 58, wherein said coating is an anti-strip agent.
